(19) United States
(12) Patent Application Publication
(10) Pub. No.: US 2023/0115987 A1
(43) Pub. Date: Apr. 13, 2023

(54) DATA ADJUSTMENT SYSTEM, DATA ADJUSTMENT DEVICE, DATA ADJUSTMENT METHOD, TERMINAL DEVICE, AND INFORMATION PROCESSING APPARATUS

(71) Applicant: Sony Group Corporation, Tokyo (JP)

(72) Inventor: Kenji SUZUKI, Tokyo (JP)

(73) Assignee: Sony Group Corporation, Tokyo (JP)

(21) Appl. No.: 17/913,856

(22) PCT Filed: Mar. 23, 2021
(86) PCT No.: PCT/JP2021/011944

§ 371 Date: Sep. 23, 2022

(30) Foreign Application Priority Data
Mar. 31, 2020 (JP) 2020-064522

(51) Int. Cl. G06N 3/08

(52) U.S. Cl. CPC G06N 3/08

(57) ABSTRACT

A data adjustment system according to the present disclosure includes an information processing apparatus, and a terminal device, in which the information processing apparatus includes, a measuring unit configured to measure a degree of influence of learning data on learning in a neural network, the learning data being used for the learning, and an adjustment unit configured to adjust the learning data by excluding data measured as having a low degree of influence, acquiring new data from the terminal device or a database, or adding the acquired new data, the new data being data to be newly added corresponding to data measured as having a high degree of influence.

### TECHNICAL FIELD

The present disclosure relates to a data adjustment system, a data adjustment device, a data adjustment method, a terminal device, and an information processing apparatus.

### BACKGROUND ART

In various technical fields, information processing using machine learning (also simply referred to as “learning”) is utilized, and a technology for learning a model such as a neural network has been provided. In such learning, data used for learning affects performance of a model or the like of a neural network or the like to be learned, therefore data used for learning is important, and a technology related to data used for learning is provided (see, for example, Patent Document 1) .

### CITATION LIST

### Patent Document

Patent Document 1: Japanese Patent Application Laid-Open No. 2019-179457

### SUMMARY OF THE INVENTION

### Problems to Be Solved by the Invention

According to the conventional technology, learning is performed using data obtained by complementing a missing value from a candidate value.

However, the conventional technology cannot always make learning using appropriate data. For example, in the conventional technology, in a case where data that does not have a missing value but is not suitable for learning is used, the data is used as it is, and so there is a case where a model such as a neural network having desired performance cannot be learned. As described above, in the conventional technology, whether a missing value exists in the data used for learning is considered, however, it is not considered whether the data itself used for learning is suitable for learning. Therefore, it is desired to make data used for learning adjustable.

Thus, the present disclosure proposes a data adjustment system, a data adjustment device, a data adjustment method, a terminal device, and an information processing apparatus capable of making data used for learning adjustable.

### Solutions to Problems

In order to solve the above-described issues, a data adjustment system according to an embodiment of the present disclosure includes an information processing apparatus, and a terminal device, in which the information processing apparatus includes, a measuring unit configured to measure a degree of influence of learning data on learning in a neural network, the learning data being used for the learning, and an adjustment unit configured to adjust the learning data by excluding data measured as having a low degree of influence, acquiring new data from the terminal device or a database, or adding the acquired new data, the new data being data to be newly added corresponding to data measured as having a high degree of influence.

### BRIEF DESCRIPTION OF DRAWINGS

FIG. 1 is a diagram illustrating an example of data adjustment processing according to an embodiment of the present disclosure.

FIG. 2 is a conceptual diagram of data adjustment processing according to an embodiment of the present disclosure.

FIG. 3 is a diagram illustrating a configuration example of a data adjustment system according to an embodiment of the present disclosure.

FIG. 4 is a diagram illustrating a configuration example of a data adjustment device according to an embodiment of the present disclosure.

FIG. 5 is a diagram illustrating an example of a data information storage unit according to an embodiment of the present disclosure.

FIG. 6 is a diagram illustrating an example of a model information storage unit according to an embodiment of the present disclosure.

FIG. 7 is a diagram illustrating an example of a threshold information storage unit according to an embodiment of the present disclosure.

FIG. 8 is a diagram illustrating an example of a network corresponding to a model.

FIG. 9 is a diagram illustrating a configuration example of a terminal device according to an embodiment of the present disclosure.

FIG. 10 is a flowchart illustrating processing of the data adjustment device according to an embodiment of the present disclosure.

FIG. 11 is a sequence diagram illustrating a processing procedure of the data adjustment system according to an embodiment of the present disclosure.

FIG. 12 is a flowchart illustrating an example of processing of data adjustment and learning based on the degree of influence.

FIG. 13 is a hardware configuration diagram illustrating an example of a computer that realizes functions of an information processing apparatus such as the data adjustment device and the terminal device.

### MODE FOR CARRYING OUT THE INVENTION

Hereinafter, embodiments of the present disclosure will be described in detail with reference to the drawings. Note that the data adjustment system, the data adjustment device, the data adjustment method, the terminal device, and the information processing apparatus according to the present embodiment are not limited by the embodiment. Further, in each of the following embodiments, the same parts are denoted by the same reference numerals, and redundant description will be omitted.

The present disclosure will be described according to the following order of items.
1. Embodiments
1-1. Overview of data adjustment processing according to embodiment of present disclosure
1-1-1. Background and effects
1-1-2. Concept of data adjustment system
1-1-3. Influence function
1-1-4. Bayesian Deep Learning
1-1-5. Others (GAN, Grad-CAM, LIME, etc.)
1-2. Configuration of data adjustment system according to embodiment
1-3. Configuration of data adjustment device according to embodiment
1-3-1. Model (Network) example
1-4. Configuration of terminal device according to embodiment
1-5. Procedure of information processing according to embodiment
1-5-1. Procedure of processing related to data adjustment device
1-5-2. Procedure of processing related to data adjustment system
1-6. Data adjustment example based on degree of influence
1-6-1. Specific example of adjustment
2. Other embodiments
2-1. Other configuration examples
2-2. Others
3. Effects according to present disclosure
4. Hardware configuration

### 1. Embodiments

### 1-1. Overview of Data Adjustment Processing According To Embodiment of Present Disclosure

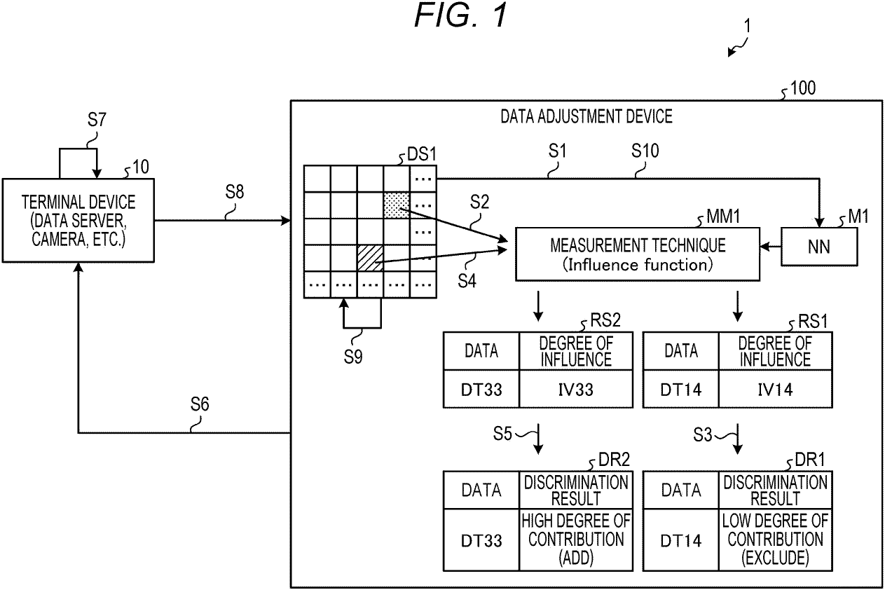

FIG. 1 is a diagram illustrating an example of data adjustment processing according to an embodiment of the present disclosure. The data adjustment processing according to an embodiment of the present disclosure is implemented by a data adjustment system 1 including a data adjustment device 100 and a terminal device 10. In FIG. 1, an overview of data adjustment processing implemented by the data adjustment system 1 will be described. FIG. 1 is a diagram illustrating an example of data adjustment processing according to an embodiment of the present disclosure.

The data adjustment device 100 is an information processing apparatus that adjusts the learning data by excluding predetermined data from the learning data used for learning of a model by machine learning or adding new data to the learning data. In FIG. 1, a case where the data adjustment device 100 executes processing of adjusting data of a data set used for learning of a deep neural network (DNN) is illustrated as an example. The data adjustment device 100 executes learning processing of learning an identification model (hereinafter, also simply referred to as a “model”), which is a DNN that performs image recognition, by using a data set. Hereinafter, the deep neural network (DNN) may be simply referred to as a neural network (NN). In FIG. 1, a case where the data adjustment device 100 learns a model used for smile detection will be described as an example. Note that the use of the model learned by the data adjustment device 100 is not limited to the smile detection, and the data adjustment device 100 learns a model used for various uses such as object recognition and impression detection according to the purpose and use of the model to be learned.

Furthermore, in FIG. 1, as an example of the terminal device 10 that provides data to the data adjustment device 100 in response to a request of the data adjustment device 100, a data server having data corresponding to the request of the data adjustment device 100 and a camera that captures data (image) corresponding to the request of the data adjustment device 100 are illustrated. Note that the terminal device 10 is not limited to the data server or the camera and may be various devices as long as the data requested by the data adjustment device 100 can be provided to the data adjustment device 100. For example, the terminal device 10 may be a moving object such as an unmanned aerial vehicle (UAV) such as a drone or a vehicle such as an automobile, or an image sensor (imager), and details on this matter will be described later.

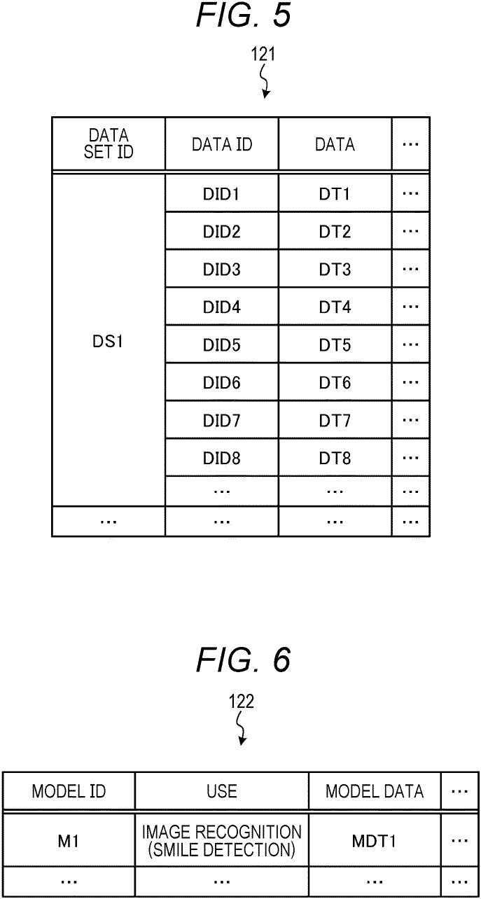

An overview of the processing illustrated in FIG. 1 will be described below. First, in the example of FIG. 1, the data adjustment device 100 learns a model M1, which is a neural network used for smile detection, by using a data set DS1 (step S1). For example, the data adjustment device 100 learns the model M1 using the data set DS1 stored in the data information storage unit 121 (see FIG. 5). In FIG. 1, each square in the data set DS1 indicates data (image), and the data set DS1 includes a large number of data (images).

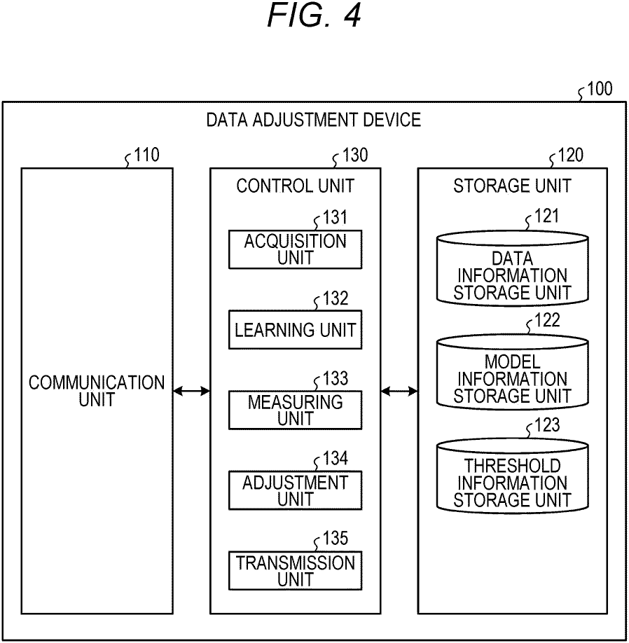

In the example of FIG. 1, the data adjustment device 100 designs a structure of a network (neural network or the like) corresponding to the model M1 stored in the model information storage unit 122 (see FIG. 6). The data adjustment device 100 designs a structure of network (network structure) of the model M1 used for smile detection. For example, the data adjustment device 100 may generate the structure of the network of the model M1 used for smile detection on the basis of information regarding the structure of the network corresponding to each use stored in advance in the storage unit 120 (see FIG. 4). For example, the data adjustment device 100 may acquire the structure information of the network of the model M1 used for smile detection from the external device.

For example, the data adjustment device 100 learns the model M1 using the data set DS1 in which a ground truth label indicating the presence or absence of a smiling face is associated with each data (image). The data adjustment device 100 performs learning processing so as to minimize the set loss function using the data set DS1 and learns the model M1. The data adjustment device 100 may use various functions as the loss function as long as the degree of influence of each data can be measured in measurement processing to be described later. Note that the loss function in the influence function will be described later.

For example, the data adjustment device 100 learns the model M1 by updating parameters such as a weight and a bias so that the output layer has a correct value with respect to the input of data. For example, in the back propagation method, the weight or bias is updated to minimize the loss function using the steepest descent method or the like using the loss function indicating how far the value of the output layer is from the correct state (ground truth label) for the neural network. For example, the data adjustment device 100 provides an input value (data) to the neural network (model M1), the neural network (model M1) calculates a predicted value on the basis of the input value, and compares the predicted value with labeled training data (ground truth label) to evaluate an error. Then, the data adjustment device 100 executes learning and construction of the model M1 by sequentially correcting the value of the binding load (synapse coefficient) in the neural network (model M1) on the basis of the obtained error. Note that the above is an example, and the data adjustment device 100 may perform the learning processing of the model M1 by various methods.

Then, the data adjustment device 100 measures the degree of influence of each data in the data set DS1 on the learning of the model M1. The data adjustment device 100 measures the degree of influence of each data in the data set DS1 on the learning of the model M1 using a method of measuring the degree of influence (measurement technique MM1). The degree of influence here shows that the larger value indicates the higher degree of contribution (contribution degree) of the data to the learning of the model M1. The larger value of the degree of influence, that is, the higher degree of influence indicates the more contributions to the improvement of the identification accuracy of the model M1. As described above, the higher degree of influence indicates that the data is more necessary for learning the model M1. For example, the higher degree of influence indicates that the data is more useful for learning the model M1.

Furthermore, regarding the degree of influence, the smaller value indicates that the data has less amount of contributions (degree of contribution) to the learning of the model M1. The smaller value of the degree of influence, that is, the lower degree of influence indicates it less contributes to the improvement of the identification accuracy of the model M1. As described above, the lower degree of influence indicates that the data is less necessary for learning the model M1. For example, the lower degree of influence indicates that the data is more harmful for learning the model M1.

FIG. 1 illustrates a case where an influence function is used as an example of the measurement technique MM1, but the influence function will be described later. Note that the measurement technique MM1 used by the data adjustment device 100 to measure the degree of influence is not limited to the influence function and any method may be used as long as a value indicating the degree of influence of each data can be acquired. For example, if there is spare time and processing resources, the data adjustment device 100 may measure the degree of influence of each data by processing of removing data one by one and relearning. In this case, the data adjustment device 100 may measure the degree of influence of the data X by processing of excluding one piece of data (data X) from the data set DS1 and relearning the data. For example, the data adjustment device 100 may measure a difference between a loss in learning in a case where the entire data set DS1 is used and a loss in learning in a case where the data X is excluded from the data set DS1 by using the degree of influence of the data X. Note that the above is an example, and the data adjustment device 100 may measure the degree of influence of each data using an influence function or another technique other than the above technique.

In FIG. 1, the data adjustment device 100 measures the degree of influence of data DT14 in the data set DS1 on the learning of the model M1 (step S2). As illustrated in a measurement result RS1, the data adjustment device 100 measures the degree of influence of the data DT14 on the learning of the model M1 as the degree of influence IV14. Note that the degree of influence IV14 is a specific value (for example, 0.2 or the like).

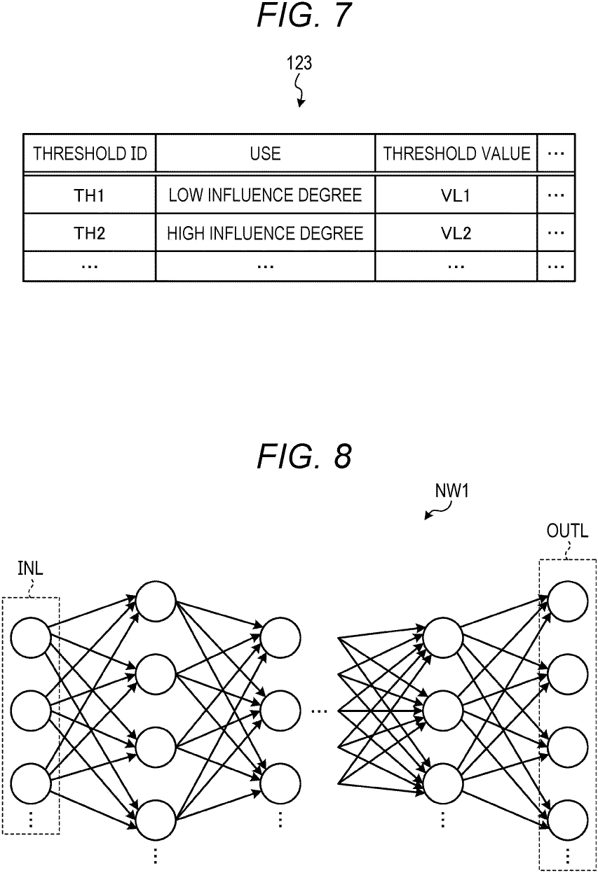

Then, the data adjustment device 100 adjusts the data set DS1 on the basis of the degree of influence IV14 of the data DT14 (step S3). First, the data adjustment device 100 discriminates whether the data DT14 is necessary for learning of the model M1 on the basis of the degree of influence IV14 of the data DT14. For example, the data adjustment device 100 uses the threshold value stored in the threshold information storage unit 123 (see FIG. 7) to discriminate whether the data DT14 is necessary for learning of the model M1.

For example, the data adjustment device 100 discriminates whether the data DT14 is necessary for learning of the model M1 using a threshold value (first threshold value TH1) used for discriminating data having a low degree of influence, that is, a low degree of contribution (also referred to as “first piece of data”). The data adjustment device 100 compares the degree of influence IV14 of the data DT14 with the first threshold value TH1, and discriminates that the data DT14 is unnecessary for learning of the model M1 in a case where the influence degree IV14 is lower than the first threshold value TH1.

In FIG. 1, since the degree of influence IV14 of the data DT14 is lower than the first threshold value TH1, the data adjustment device 100 discriminates that the data DT14 is unnecessary for learning of the model M1. Therefore, as illustrated in the discrimination result DR1, the data adjustment device 100 discriminates that the degree of contribution of the data DT14 to the learning of the model M1 is low and decides to exclude the data DT14 from the data set DS1. Then, the data adjustment device 100 adjusts the data set DS1 by excluding the data DT14 from the data set DS1. As a result, the data adjustment device 100 updates the data set DS1.

Furthermore, in FIG. 1, the data adjustment device 100 measures the degree of influence of data DT33 in the data set DS1 on the learning of the model M1 (step S4). As illustrated in a measurement result RS2, the data adjustment device 100 measures the degree of influence of the data DT33 on the learning of the model M1 as the influence degree IV33. Note that the influence degree IV33 is a specific value (for example, 0.7 or the like).

Then, the data adjustment device 100 adjusts the data set DS1 on the basis of the influence degree IV33 of the data DT33 (step S5). First, the data adjustment device 100 discriminates whether the data DT33 is necessary for learning of the model M1 on the basis of the influence degree IV33 of the data DT33. For example, the data adjustment device 100 uses the threshold value stored in the threshold information storage unit 123 to discriminate whether the data DT33 is necessary for learning of the model M1. In FIG. 1, since the influence degree IV33 of the data DT33 is equal to or more than the first threshold value TH1, the data adjustment device 100 discriminates that the data DT33 is not unnecessary for learning of the model M1.

Then, the data adjustment device 100 discriminates whether the data DT33 is necessary for learning of the model M1 using a threshold value (second threshold value TH2) used for discriminating data having a high degree of influence, that is, a high degree of contribution (also referred to as “second piece of data”). Note that the second threshold value TH2 is larger than the first threshold value TH1. The data adjustment device 100 compares the influence degree IV33 of the data DT33 with the second threshold value TH2, and discriminates that the data DT33 is necessary for learning of the model M1 in a case where the influence degree IV33 is higher than the second threshold value TH2.

In FIG. 1, since the influence degree IV33 of the data DT33 is higher than the second threshold value TH2, the data adjustment device 100 discriminates that the data DT33 is necessary for learning of the model M1. Therefore, as illustrated in a discrimination result DR2, the data adjustment device 100 discriminates that the degree of contribution of the data DT33 to the learning of the model M1 is high and decides to add data corresponding to the data DT33 to the data set DS1. Then, the data adjustment device 100 adjusts the data set DS1 by adding the data corresponding to the data DT33 to the data set DS1. As a result, the data adjustment device 100 updates the data set DS1.

In FIG. 1, the data adjustment device 100 requests the terminal device 10 for data corresponding to the data DT33 (step S6). The data adjustment device 100 transmits request information for requesting data (also referred to as “new data”) corresponding to the data DT33 to the terminal device 10. The data adjustment device 100 requests the terminal device 10 for new data similar to the data DT33. The data adjustment device 100 requests the terminal device 10 for data similar to the data DT33 by transmitting information indicating the data DT33 to the terminal device 10. For example, the data adjustment device 100 requests the terminal device 10 for data similar to the data DT33 by transmitting the data DT33 to the terminal device 10.

The terminal device 10 that has received the request from the data adjustment device 100 collects data corresponding to the request information (step S7). The terminal device 10 collects data similar to the data DT33 as data (also referred to as “provision data”) to be provided to the data adjustment device 100.

For example, in a case where the terminal device 10 is a data server, the terminal device 10 extracts data corresponding to the request information from a data group held thereby to collect the data corresponding to the request information. For example, the terminal device 10 collects data corresponding to the request information by extracting data similar to the data DT33 from the held database. For example, the terminal device 10 compares the data DT33 with each data in the database, and extracts data having the similarity with the data DT33 within a predetermined threshold as the provision data. For example, the terminal device 10 may calculate the similarity between the data DT33 and each data in the database using a model that outputs the similarity of the image, and extract data having the similarity with the data DT33 within a predetermined threshold as the provision data.

Further, for example, in a case where the terminal device 10 is a camera, the terminal device 10 extracts data corresponding to the request information from captured data to collect the data corresponding to the request information. For example, the terminal device 10 collects data corresponding to the request information by extracting data similar to the data DT33 from a plurality of captured images (data). For example, the terminal device 10 compares the data DT33 with each of the captured images, and extracts data having the similarity with the data DT33 within a predetermined threshold as the provision data. Note that the terminal device 10 may be controlled to capture an image similar to the data DT33. In this case, the terminal device 10 captures an image similar to the data DT33 and collects the image as the provision data.

Then, the terminal device 10 provides the data adjustment device 100 with the provision data (step S8). The terminal device 10 transmits data similar to the collected data DT33 to the data adjustment device 100 as provision data.

The data adjustment device 100 that has acquired the provision data from the terminal device 10 adds the acquired provision data to the data set DS1 (step S9). As a result, the data adjustment device 100 adds data similar to the data DT33 having a high degree of contribution to the data set DS1.

Note that FIG. 1 illustrates a case where the data adjustment device 100 acquires the new data to be added from the terminal device 10 and adds the new data to the data set DS1, but the data adjustment device 100 may add the new data acquired by any means to the data set DS1.

For example, the data adjustment device 100 may acquire data (new data) corresponding to the data DT33 from the storage unit 120 and add the data to the acquired data set DS1. In this case, the data adjustment device 100 acquires (extracts) data similar to the data DT33 from the storage unit 120 among the data not included in the data set DS1, and adds the acquired (extracted) data to the data set DS1. As described above, the data adjustment device 100 may acquire data similar to data having a high degree of contribution (second piece of data) in the data set DS1 from the storage unit 120 and add the data to the data set DS1.

Furthermore, for example, the data adjustment device 100 may generate data corresponding to the data DT33 and add the generated data (new data) to the data set DS1. In this case, the data adjustment device 100 may generate data similar to the data DT33 and add the generated data to the data set DS1. For example, the data adjustment device 100 generates data similar to the data DT33 using various technologies such as data extension as appropriate, and adds the generated data to the data set DS1. As described above, the data adjustment device 100 may generate data similar to data having a high degree of contribution (second piece of data) in the data set DS1 and add the generated data to the data set DS1.

Note that, in FIG. 1, for the sake of explanation, only the processing for the two pieces of data of the data DT14 and the data DT33 is illustrated, but the data adjustment device 100 executes similar processing for all the data in the data set DS1. For example, the data adjustment device 100 measures the degree of influence for all data in the data set DS1. Then, the data adjustment device 100 excludes data having a low degree of contribution from the data set DS1. In addition, the data adjustment device 100 adds data similar to the data having a high degree of contribution to the data set DS1. As a result, the data adjustment device 100 executes adjustment processing to adjust the data set DS1.

Then, the data adjustment device 100 learns the model M1 again using the adjusted data set DS1 (step S10). For example, the data adjustment device 100 learns the model M1 again using the adjusted data set DS1 in which data having a low degree of contribution such as the data DT14 is excluded and data similar to data having a high contribution degree such as the data DT33 is added.

As described above, the data adjustment device 100 executes the adjustment processing to adjust the data set DS1 by excluding data having a low degree of contribution from the data set DS1 and adding data similar to data having a high degree of contribution to the data set DS1. As described above, the data adjustment device 100 can adjust the data used for learning by excluding or adding data in accordance with the degree of contribution of each data to learning.

In addition, in a case where data corresponding to data having a high degree of contribution is added, the data adjustment device 100 requests the data from the terminal device 10. Then, the terminal device 10 that has received the request provides data corresponding to the request as provision data to the data adjustment device 100. As a result, the terminal device 10 can make the data used for learning adjustable.

As described above, the data adjustment system 1 can make data used for learning adjustable by excluding data having a low degree of contribution from a data set or adding data corresponding to data having a high degree of contribution to the data set.

### 11. Background and Effects, etc

Here, the background, effects, and the like of the above-described data adjustment system 1 will be described. Deep learning realizes prediction exceeding human ability. However, decision basis of the artificial intelligence is unknown, and the decision is made by the black box. To improve the accuracy of deep learning, a large amount of data is required, and that causes a problem. In recent years, research on elucidation of the decision basis has become active. The basis of decision making of deep learning is finding the cause from the result. With such a scientific approach, it is possible to understand what data is necessary for improving the accuracy of deep learning.

Conventionally, although artificial intelligence has advanced performance, it has been called a black box. Deep learning has a structure that mimics human neurons, and a model is formed by optimizing a large number of parameters, and is hard to be explained due to its complexity. In recent years, research on explainable artificial intelligence has become active, and various algorithms have been proposed. Research remains at an academic level, and deployment to a practical system is delayed.

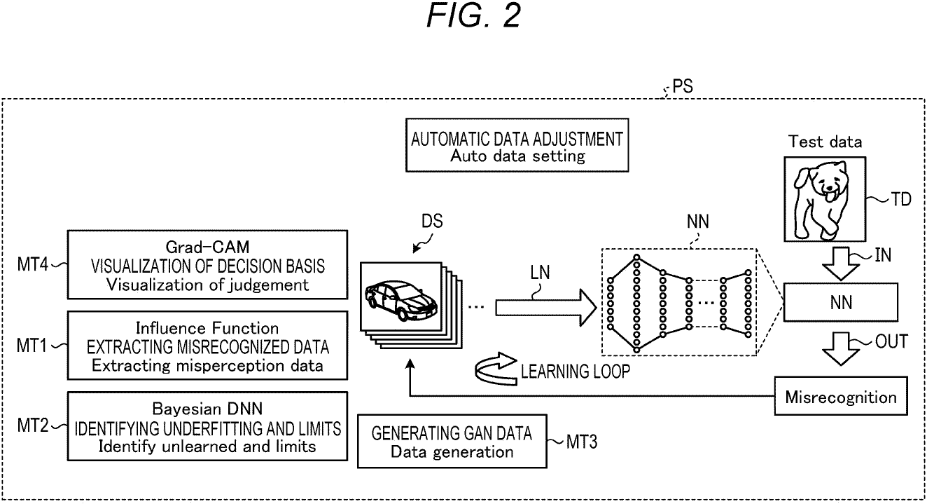

By searching for the cause from the result decided by the deep learning, necessary data can be selected. By using technologies such as selection of harmful data and useful data, detection of data shortage due to underfitting, limits of estimation due to noise, and mislabeled data, data in deep learning can be selected. It is very difficult for a human to adjust these operations. Therefore, a system that readjusts learning data by itself, such as the data adjustment system 1, ascertains the cause from erroneous determination data and automatically prepares an optimal relearning data set. In the data adjustment system 1, relearning is executed using the adjusted data set, and these are repeated by a loop, so that prediction accuracy can be further improved. Explanation on this matter will be given below with reference to FIG. 2.

### 12. Concept of Data Adjustment System

FIG. 2 is a conceptual diagram of data adjustment processing according to an embodiment of the present disclosure. A processing PS in FIG. 2 is an overall conceptual diagram of an automatic data adjustment processing incorporated by the data adjustment system 1. Any device included in the data adjustment system 1 such as the data adjustment device 100 and the terminal device 10 may perform the processing whose subject is the data adjustment system 1 described below.

First, an overall processing overview of the processing PS in FIG. 2 will be described. In the processing PS by the data adjustment system 1, as illustrated in the learning LN in FIG. 2, a processing of learning a model NN that is a neural network using the data set DS is performed. In the processing PS by the data adjustment system 1, test data such as the data TD is input to the learned model NN as indicated by an input IN in FIG. 2.

Then, in the processing PS by the data adjustment system 1, an output (identification result) is obtained from the model NN according to the input of the test data, as illustrated in an output OUT in FIG. 2. Then, in the processing PS by the data adjustment system 1, in a case where the output (identification result) from the model NN is an error (misrecognition), learning is performed by feeding the information back.

Hereinafter, each processing will be individually described. The data adjustment system 1 specifies a cause of erroneous determination (misrecognition) in the data. For example, as illustrated in the technique MT1, the data adjustment system 1 distributes (classifies) the harmful data or the useful data by the influence function. The data adjustment system 1 repeats an arithmetic loop to minimize the loss function of deep learning by removing harmful data.

For example, the influence function can select an optimal model. The accuracy of the data varies depending on the model. For example, the data adjustment system 1 may be configured to automatically select a model with less harmful data distribution.

For example, as illustrated in the technique MT2, the data adjustment system 1 can discriminate (recognize) a case where accuracy is not obtained due to lack of data by the Bayesian DNN. In this case, the data adjustment system 1 can improve the accuracy by automatically replenishing necessary data from the data lake and relearning. In addition, for example, the data adjustment system 1 can complement data by generating the data by a Generative Adversarial Network (GAN) as described in the technique MT3. Note that details of the Bayesian DNN and the GAN will be described later.

Furthermore, Bayesian DNN is a technology that can discriminate (recognize) a case where accuracy cannot be expected despite further learning due to noise or the like. After the accuracy is improved to some extent by spinning the learning loop as described above, the data adjustment system 1 can notify (report) a human of the limit at which the accuracy cannot be further improved.

In the data adjustment system 1, for the decision basis, a human can understand how the decision was made by visualizing what causes the decision in Gradient-weighted Class Activation Mapping (Grad-CAM), Local Interpretable Model-agnostic Explanations (LIME), or the like. Note that details of the Grad-CAM and LIME will be described later. As described above, the data adjustment system 1 is a self-growing learning system in which data automatic adjustment is integrated in learning by deep learning, for example.

As described above, the data adjustment system 1 inputs test data to a network learned by deep learning. The data adjustment system 1 is a system that automatically adjusts data by identifying a cause of erroneous determination. The data adjustment system 1 learns again using the adjusted data to generate a network. The data adjustment system 1 performs a test to find out the cause of the remaining erroneous determination. The data adjustment system 1 repeats a loop of automatically adjusting and relearning data so as to improve accuracy. The data adjustment system 1 performs useful/harmful data determination and identification of underfitting/limits using an influence function, a Bayesian DNN, or the like in these cause solving techniques. As described above, the data adjustment system 1 is characterized in that data deep learning is integrated.

For example, in deep learning requiring a large amount of data, the data adjustment system 1 can automatically select high-quality data and improve accuracy. The data adjustment system 1 can automatically select data to be improved in accuracy by specifying a scientific cause without human intuition in adjusting the data. Since the data adjustment system 1 is a loop system, accuracy can be improved by allowing a computer to perform calculation without human work.

### 13. Influence Function

Each technique in the data adjustment system 1 will be described below. First, the influence function will be described. The data adjustment system 1 quantitatively analyzes the influence of each data in a data set on the generated model (parameter) by the influence function. For example, the data adjustment system 1 formulates the influence of the presence or absence of certain (learning) data on the accuracy (output result) of the model using an influence function. For example, the data adjustment system 1 measures the degree of influence given to learning by each data without relearning using a data set excluding each data to be measured for influence. Hereinafter, the measurement of the degree of influence using the influence function will be described using a mathematical formula or the like.

The influence function is also used, for example, as a method for explaining a black box model of machine learning.

Note that the influence function is disclosed in, for example, the following literature.
Understanding Black-box Predictions via Influence Functions, Pang Wei Kho and Percy Liang <https://arxiv.org/abs/1703.04730>

The data adjustment system 1 can calculate the degree of contribution of data to machine learning by using the influence function, and can measure (recognize) how much favorable influence or adverse influence a certain data has. For example, the data adjustment system 1 calculates (measures) the degree of influence by an algorithm, data, or the like as described below. Hereinafter, a case where an image is used as input data will be described as an example.

For example, an input x (image) is regarded as a prediction problem in machine learning based on an output y (label). Each image is labeled, that is, an image and a ground truth label are associated with each other. For example, if there are n sets (n is an arbitrary natural number) of images and labels (data sets), each labeled image z (which may be simply described as “image z”) is as in the following formula (1).

$${z}_{1} , {z}_{2} , ⋯ , {z}_{n} {z}_{i} = \left({x}_{i} , {y}_{i}\right) ∈ X \times Y ⋯ \left(1\right)$$

Here, assuming that a loss at a parameter θ ∈ θ of the model at a certain point z (image z) is L (z, θ), the empirical loss in all n pieces of data can be expressed as the following formula (2).

$$\frac{1}{n} {\sum }_{i = 1}^{n} L \left({z}_{i} , θ\right) ⋯ \left(2\right)$$

In addition, the minimization of the empirical loss means finding (deciding) a parameter that minimizes the loss, and thus can be expressed as the following formula (3) .

$$\hat{θ} ≡ a r g m i {n}_{θ ∈ θ} \frac{1}{n} {\sum }_{i = 1}^{n} L \left({z}_{i} , θ\right) ⋯ \left(3\right)$$

For example, the data adjustment system 1 calculates a parameter ((left side of formula (3))) that minimizes the loss using formula (3). Here, it is assumed that the empirical loss can be second-order differentiation and is a convex function with respect to the parameter θ. Hereinafter, how to perform calculation with the aim of understanding the degree of influence of data that is the training point of the machine learning model will be described. If there is no data of a certain training point, what kind of influence will be given to the machine learning model will be considered.

Note that a parameter (variable) in which “^” is added above a certain character, such as a parameter (variable) in which “^” (hat) is added above “θ” indicated on the left side of formula (3), indicates, for example, a predicted value. Hereinafter, in a case of referring to the parameter (variable) in which “^” is added above “θ” indicated on the left side of formula (3) in the sentence, it is expressed as “θ^” in which “^” is described following “θ”. In a case where a certain training point z (image z) is excluded from the machine learning model, it can be expressed as the following formula (4).

$${\hat{θ}}_{- z} ≡ a r g m i {n}_{θ ∈ θ} \frac{1}{n} {\sum }_{{z}_{i} \neq z} L \left({z}_{i} , θ\right) ⋯ \left(4\right)$$

For example, the data adjustment system 1 calculates a parameter (the left side of formula (4)) in a case where learning is performed using formula (4) without using certain learning data (image z). For example, the degree of influence is a difference between when the training point z (image z) is excluded and when there are all data points including the training point z. This difference is expressed by the following formula (5) .

$${\hat{θ}}_{- z} - \hat{θ} ⋯ \left(5\right)$$

Here, if recalculation is performed for a case where the image z is excluded, the calculation cost is very high. Therefore, the data adjustment system 1 performs calculation without recalculating (relearning) the case where the image z is excluded by effective approximation as described below using Influence functions.

This idea is a method of calculating a change in a parameter assuming that the image z is weighted by minute ε. Here, a new parameter (the left side of formula (6)) is defined using the following formula (6).

$${\hat{θ}}_{ε , z} ≡ a r g m i {n}_{θ ∈ Θ} \frac{1}{n} {\sum }_{i = 1}^{n} L \left({z}_{i} , θ\right) + ε L \left(z , θ\right) ⋯ \left(6\right)$$

By utilizing the results of a prior study by Cook and Weisberg in 1982, the degree of influence of the weighted image z with the parameter θ^ ((left side of formula (3))) can be expressed as the following formulas (7), (8).

$${l}_{u p p a r a m s} \left(z\right) ≡ \frac{d {\tilde{θ}}_{ε , z}}{d ε} \left|{}_{∈ = 0} = - {H}_{\hat{θ}}^{- 1}\right) {∇}_{θ} L \left(z , \hat{θ}\right) ⋯ \left(7\right)$$

$${H}_{\hat{θ}} ≡ \frac{1}{n} {\sum }_{i = 1}^{n} {∇}_{θ}^{2} L \left({z}_{i} , \hat{θ}\right) ⋯ \left(8\right)$$

Note that prior study by Cook and Weisberg is disclosed in, for example, the following literature.
Residuals and Influence in Regression, Cook, R.D. and Weisberg, S <https://conservancy.umn.edu/handle/11299/37076>

For example, formula (7) represents an influence function corresponding to a certain image z. For example, formula (7) represents a change amount of a parameter with respect to minute ε. In addition, for example, formula (8) represents Hessian (Hessian matrix). Here, it is assumed that the matrix is a Hessian matrix having a positive definite value, and an inverse matrix also exists. Assuming that removing the data point z (image z), which is a certain point, is the same as being weighted by “ε = -⅟n”, the parameter change when removing the image z can be approximately expressed by the following formula (9).

$${\hat{θ}}_{- z} - \hat{θ} \approx - \frac{1}{n} {I}_{u p p a r a m s} \left(z\right) ⋯ \left(9\right)$$

That is, the data adjustment system 1 can measure (obtain) the degree of influence when the data point z (image z) is excluded without performing relearning.

Next, the data adjustment system 1 measures (obtains) the degree of influence on the loss at a certain test point ztest using the following formulas (10-1) to (10-3).

$$\begin{matrix}{I}_{u p , l o s s} \left(z , {z}_{t e s t}\right) ≡ \frac{d L \left({z}_{t e s t} , {θ}_{∈ , z}\right)}{d ∈} {\vert}_{∈ = 0} & ⋯ \left(10 - 1\right) \\ = {∇}_{θ} L {\left({z}_{t e s t} , \hat{θ}\right)}^{T} \frac{d {θ}_{∈ , z}}{d ∈} {\vert}_{∈ = 0} & ⋯ \left(10 - 2\right) \\ = - {∇}_{θ} L {\left({z}_{t e s t} , \hat{θ}\right)}^{T} {H}_{\hat{θ}}^{- 1} {∇}_{θ} L \left(z , \hat{θ}\right) & ⋯ \left(10 - 3\right)\end{matrix}$$

In this manner, the degree of influence of the weighted image z at a certain test point ztest can be formulated. Therefore, the data adjustment system 1 can measure (obtain) the degree of influence of data in the machine learning model by this calculation. For example, the right side of formula (10-3) includes a gradient with respect to loss of certain data, an inverse matrix of Hessian, a gradient of loss of certain learning data, and the like. For example, the influence of certain data on the prediction (loss) of the model can be obtained by formula (10-3). Note that the above is an example, and the data adjustment system 1 may appropriately execute various calculations and measure the degree of influence of each image on learning.

### 14. Bayesian Deep Learning

Next, Bayesian Deep Learning will be described. The data adjustment system 1 can estimate, for example, what causes the accuracy of the model not to be improved in Bayesian Deep Learning using a technique MT2 (Bayesian DNN). In this manner, the data adjustment system 1 can make a determination regarding the accuracy of the model by the Bayesian Deep Learning technique. Bayesian Deep Learning will be described below while describing the premise.

First, in general, the inference of the deep learning model is highly accurate, but there is a limit on the inference. It is very important to know the limit not to be able to perform inference in using deep learning. However, the uncertainty of deep learning cannot be completely eliminated. What the uncertainty is in deep learning will be described below.

There are two types of uncertainty in deep learning. Uncertainty in deep learning can be divided into accidental uncertainty (Aleatoric uncertainty) and uncertainty in recognition (Epistemic uncertainty). The former Aleatoric uncertainty is due to observation noise and is not due to lack of data. For example, a case such as a hidden and invisible image (occlusion) corresponds to (matches) this (Aleatoric uncertainty). Since the mouth of the face of the masked person is originally hidden by the mask, it cannot be observed as data. On the other hand, the latter Epistemic uncertainty refers to the uncertainty due to the lack of data. Epistemic uncertainty can be improved if sufficient data is present. However, in general, it has been considered difficult to clarify epistemic uncertainties in the imaging field.

The proposal of Bayesian Deep Learning has made it possible to reveal uncertainty.

Note that the Bayesian Deep Learning is disclosed in, for example, the following literature.
What Uncertainties Do We Need in Bayesian Deep Learning for Computer Vison, NIPS 2017, Alex Kendall and Yarin Gal <https://papers.nips.cc/paper/7141-what-uncertainties-do-we-need-in-bayesian-deep-learning-for-computer-vision.pdf>

Bayesian deep learning is considered by combining Bayesian estimation and deep learning. By using Bayesian inference, how the estimation result varies can be understood, and thus, uncertainty can be evaluated.

Bayesian deep learning is a technique of estimating from a result of dispersion obtained in inference using a dropout in the learning of deep learning. Dropout is a technique that is very often used to reduce overfitting by randomly reducing the number of neurons in each layer.

Mathematical theories about the role of the dropout in Bayesian deep learning are disclosed, for example, in the following literature.
Dropout as Bayesian Approximation: Representing Model Uncertainty in Deep Learning, ICML 2016, Yarin Gal and Zoubin Ghahramani <https://arxiv.org/pdf/1506.02142.pdf>

In conclusion, using dropout in deep learning is performing Bayesian learning. For example, the value obtained by learning is not deterministic, and the data adjustment system 1 can perform calculation by combining a posterior distribution of weights with a dropout. For example, the data adjustment system 1 can estimate the variance of the posterior distribution from the variation in which the plurality of outputs is generated by the plurality of dropout coefficients.

The Bayesian deep learning performs sampling from the weight distribution by using the dropout not only at the time of learning but also at the time of inference. For example, the data adjustment system 1 can perform sampling from the weight distribution by using the dropout not only at the time of learning but also at the time of inference using the Monte Carlo dropout technique. For example, the data adjustment system 1 can obtain the uncertainty of the inference result by repeating inference many times for the same input. The network learned using the dropout has a structure in which some neurons are missing. Therefore, when an input image is input and inferred, the data adjustment system 1 can obtain an output that passes through the neuron missing by the dropout and is characterized by the weight. Furthermore, when the same image is input, the images are output through different paths in the network, so that the weighted outputs are different from each other. That is, the network by the dropout can obtain different output distributions at the time of inference for the same input image. A large variance of the output means that the model has a large uncertainty. The average of the distribution by multiple inferences means a final prediction value, and the variance means uncertainty of the prediction value. Bayesian deep learning represents uncertainty from the variance of the output at the time of this inference. The data adjustment system 1 can perform estimation (decision) regarding model uncertainty by the Bayesian deep learning as described above.

### 15. Others (GAN, Grad-CAM, LIME, etc.)

The data adjustment system 1 is not limited to the above-described influence function and Bayesian deep learning, and may use various techniques. In this regard, explanation will be given below.

The data adjustment system 1 may automatically generate data (learning data) used for learning by appropriately using various techniques. For example, the data adjustment system 1 may (automatically) generate the learning data by the GAN.

Note that the GAN is disclosed in, for example, the following literature.
Generative Adversarial Networks, Ian J. Goodfellow et al. <https://arxiv.org/abs/1406.2661>

The data adjustment system 1 may generate data having a high degree of influence by Gan from data measured to have a high degree of influence by influence functions. For example, the data adjustment system 1 may generate data having a high degree of influence by a GAN architecture including a discriminator that identifies an image having a high degree of influence and a generator that generates an image having a high degree of influence. Note that the above is an example, and the data adjustment system 1 may generate data having a high degree of influence by appropriately using Gan technology.

The data adjustment system 1 may visualize the basis regarding the output (decision) of the model by appropriately using various techniques. For example, the data adjustment system 1 generates basis information for visualizing the basis regarding the output (determination) of the model after the input of the image by Grad-CAM. The data adjustment system 1 generates, by the Grad-CAM, basis information indicating the basis that the model M1 that detects a smiling face has determined the presence or absence of a smiling face. For example, the data adjustment system 1 generates basis information by processing related to Grad-CAM as disclosed in the following literature. The data adjustment system 1 generates basis information indicating the basis for the output of the model M1 using the technology of Grad-CAM, which is a visualization technique applicable to all networks including CNN. For example, the data adjustment system 1 can visualize a portion affecting each class by calculating a weight of each channel from the final layer of the CNN and multiplying the weight. As described above, the data adjustment system 1 can visualize which part of the image is focused and a decision is made in the neural network including the CNN.
Grad-CAM: Visual Explanations from Deep Networks via Gradient-based Localization <https://arxiv.org/abs/1610.02391>

Note that description of the technology of Grad-CAM is omitted as appropriate, but the data adjustment system 1 generates the basis information by the technique of Grad-CAM (see the above literature). For example, the data adjustment system 1 designates a target type (class) and generates information (image) corresponding to the designated class. For example, the data adjustment system 1 generates information (image) for the designated class by various processes such as backpropagation using the technology of Grad-CAM. For example, the data adjustment system 1 designates the class of the type “smile”, and generates the image related to the basis information corresponding to the type “smile”. For example, the data adjustment system 1 generates an image indicating a range (region) gazed for recognition (classification) of the type “smile” in the form of a so-called heat map (color map).

Further, the data adjustment system 1 stores data (image) to be input and basis information indicating the basis of the decision result in association with each other in the storage unit 120 (see FIG. 4) as a log (history). As a result, it is possible to verify what kind of input the data adjustment system 1 has made to perform the subsequent operation. In addition, for example, the data adjustment system 1 may use logs of data (image) as an input stored in the storage unit 120 and basis information indicating the basis of the decision result for various processes. For example, the data adjustment system 1 may generate data using a log of the data (image) as the input and the basis information indicating the basis of the decision result. For example, the data adjustment system 1 may generate the image in which the input image is changed so as to include the image of the region indicated as the basis by the heat map as the basis information. Note that the above is an example, and the data adjustment system 1 may generate data from the log appropriately using various techniques.

Note that the basis information generated by the data adjustment system 1 is not limited to an image such as a heat map, and may be information in various formats such as character information and audio information. In addition, the data adjustment system 1 may visualize the basis regarding the output (decision) of the model by not only Grad-CAM but also appropriately using various techniques. For example, the data adjustment system 1 may generate the basis information by a technique such as LIME or TCAV (Testing with Concept Activation Vectors).

For example, the data adjustment system 1 may generate the basis information using the technology of LIME. For example, the data adjustment system 1 may generate the basis information by processing related to LIME as disclosed in the following literature.
“Why Should I Trust You?”: Explaining the Predictions of Any Classifier <https://arxiv.org/abs/1602.04938>

Note that description of the technology of LIME is omitted as appropriate, but the data adjustment system 1 generates the basis information by the technique of LIME (see the above literature). For example, the data adjustment system 1 generates another model (basis model) that is locally approximated to indicate a reason (basis) why the model has made such a decision. The data adjustment system 1 generates a locally approximate basis model for a combination of input information and an output result corresponding to the input information. Then, the data adjustment system 1 generates the basis information using the basis model. Further, data adjustment system 1 may use a calculation method (generation method) of the basis information such as “Testing with Concept Activation Vectors” (test in which directionality to enable the concept is considered) called TCAV as disclosed in the following literature.
Interpretability Beyond Feature Attribution: Quantitative Testing with Concept Activation Vectors (TCAV) <https://arxiv.org/pdf/1711.11279.pdf>

For example, the data adjustment system 1 generates a plurality of pieces of input information obtained by duplicating or changing input information (target input information) serving as a basis of an image or the like. Then, the data adjustment system 1 inputs each of the plurality of pieces of input information to a model (explanation target model) to be a generation target of the basis information, and outputs a plurality of pieces of output information corresponding to each piece of input information from the explanation target model. Then, the data adjustment system 1 learns the basis model using a combination (pair) of each of the plurality of pieces of input information and each of the plurality of pieces of corresponding output information as learning data. As described above, the data adjustment system 1 generates the basis model that performs local approximation with another interpretable model (such as a linear model) for the target input information.

As described above, in a case where the data adjustment system 1 obtains the output of the model for a certain input, the data adjustment system 1 generates the basis model for indicating the basis (local surrogate) of the output. For example, the data adjustment system 1 generates an interpretable model such as a linear model as a basis model. The data adjustment system 1 generates the basis information on the basis of information such as each parameter of the basis model such as a linear model. For example, the data adjustment system 1 generates the basis information indicating that the influence of the feature amount having the large weight is large among the feature amounts of the basis model such as a linear model.

As described above, the data adjustment system 1 generates the basis information on the basis of the basis model learned using the input information and the output result of the model. As described above, the data adjustment system 1 may generate the basis information on the basis of the state information including the output result of the model after the input information to the model is input.

### 1-2. Configuration of Data Adjustment System According to Embodiment

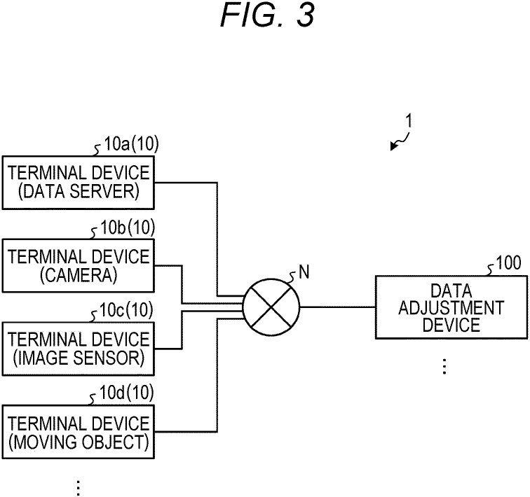

The data adjustment system 1 illustrated in FIG. 3 will be described. The data adjustment system 1 is an information processing system that implements adjustment processing for adjusting learning data. As illustrated in FIG. 3, the data adjustment system 1 includes a data adjustment device 100 and a plurality of terminal devices 10a, 10b, 10c, and 10d. Note that, in a case where the terminal devices 10a, 10b, 10c, 10d, and the like are not distinguished, they may be referred to as terminal devices 10. In addition, although FIG. 3 illustrates four terminal devices 10a, 10b, 10c, and 10d, the data adjustment system 1 may include more than four terminal devices 10 (for example, 20 or 100 or more). The terminal device 10 and the data adjustment device 100 are communicably connected in a wired or wireless manner via a predetermined communication network (network N). FIG. 3 is a diagram illustrating a configuration example of a data adjustment system according to the embodiment. Note that the data adjustment system 1 illustrated in FIG. 3 may include a plurality of data adjustment devices 100.

The data adjustment device 100 is an information processing device (computer) that measures a degree of influence given to learning by data included in a data set used for the learning of a model by machine learning, and adjusts the data set on the basis of a measurement result. In addition, the data adjustment device 100 executes learning processing using a data set. Furthermore, the data adjustment device 100 requests the terminal device 10 for data to add to the data set.

The terminal device 10 is a computer that provides data to the data adjustment device 100 in response to a request from the data adjustment device 100. In the example of FIG. 3, the terminal device 10a is a data server that holds data. The terminal device 10a may be a data server that holds data such as a moving image, an image, and character information. For example, the terminal device 10a may be a data server that holds content data for television, movies, and music, or the like.

Furthermore, in the example of FIG. 3, the terminal device 10b is a camera having an imaging function. The terminal device 10b is a camera that captures a moving image or an image and holds captured data.

In the example of FIG. 3, the terminal device 10c is an image sensor (imager) having an imaging function. For example, the terminal device 10c has a function of communicating with the data adjustment device 100, and has a function of transmitting a captured image or moving image to the data adjustment device 100. For example, the terminal device 10c captures an image or a moving image and transmits the captured image or moving image to the data adjustment device 100 in response to a request from the data adjustment device 100.

In the example of FIG. 3, the terminal device 10d is a moving object such as a UAV such as a drone or a vehicle such as an automobile. For example, the terminal device 10d has a function of communicating with the data adjustment device 100, and may perform movement in response to a request from the data adjustment device 100. The terminal device 10d has an imaging function such as an image sensor (imager), moves to a position in response to a request from the data adjustment device 100, captures an image or a moving image at the position, and transmits the captured image or moving image to the data adjustment device 100.

Note that the terminal device 10 may be any device as long as the processing in the embodiment can be implemented. The terminal device 10 may be, for example, a device such as a smartphone, a tablet terminal, a notebook personal computer (PC), a desktop PC, a mobile phone, or a personal digital assistant (PDA). The terminal device 10 may be a wearable terminal (wearable device) or the like worn on a user’s body. For example, the terminal device 10 may be a wristwatch-type terminal, a glasses-type terminal, or the like. Furthermore, the terminal device 10 may be a so-called home appliance such as a television or a refrigerator. For example, the terminal device 10 may be a robot that interacts with a human (user), called a smart speaker, an entertainment robot, or a home robot. Furthermore, the terminal device 10 may be a device disposed at a predetermined position such as a digital signage.

### 1-3. Configuration of Data Adjustment Device According to Embodiment

Next, a configuration of the data adjustment device 100, which is an example of the data adjustment device that executes the data adjustment processing according to the embodiment, will be described. FIG. 4 is a diagram illustrating a configuration example of the data adjustment device 100 according to an embodiment of the present disclosure.

As illustrated in FIG. 4, the data adjustment device 100 includes a communication unit 110, a storage unit 120, and a control unit 130. Note that the data adjustment device 100 may include an input unit (for example, a keyboard, a mouse, or the like) that receives various operations from an administrator or the like of the data adjustment device 100, and a display unit (for example, a liquid crystal display or the like) that displays various types of information.

The communication unit 110 is implemented by, for example, a network interface card (NIC) or the like. Then, the communication unit 110 is connected to the network N (see FIG. 3) in a wired or wireless manner, and transmits and receives information to and from another information processing apparatuses such as the terminal device 10. Furthermore, the communication unit 110 may transmit and receive information to and from the terminal device 10.

The storage unit 120 is implemented by, for example, a semiconductor memory element such as a random access memory (RAM) or a flash memory, or a storage device such as a hard disk or an optical disk. As illustrated in FIG. 4, the storage unit 120 according to the embodiment includes a data information storage unit 121, a model information storage unit 122, a threshold information storage unit 123, and a knowledge information storage unit 125.

The data information storage unit 121 according to the embodiment stores various types of information regarding data used for learning. The data information storage unit 121 stores a data set used for learning. FIG. 5 is a diagram illustrating an example of a data information storage unit according to an embodiment of the present disclosure. For example, the data information storage unit 121 stores various types of information regarding various types of data such as learning data used for learning and evaluation data used for accuracy evaluation (measurement). FIG. 5 illustrates an example of the data information storage unit 121 according to the embodiment. In the example of FIG. 5, the data information storage unit 121 includes items such as “data set ID”, “data ID”, and “data”.

The “data set ID” indicates identification information for identifying the data set. The “data ID” indicates identification information for identifying an object. In addition, “data” indicates data corresponding to the object identified by the data ID. That is, in the example of FIG. 5, vector data (data) corresponding to an object is registered in association with a data ID for identifying the object.

The example of FIG. 5 illustrates that the data set (data set DS1) identified by the data set ID “DS1” includes a plurality pieces of data identified by data IDs “DID1”, “DID2”, “DID3”, and the like. For example, each piece of data (learning data) identified by the data IDs “DID1”, “DID2”, “DID3”, and the like is image information or the like used for learning the model of smile detection.

Note that the data information storage unit 121 is not limited to the above, and may store various types of information depending on the purpose. The data information storage unit 121 stores ground truth information (ground truth label) corresponding to each data in association with each data. For example, the data information storage unit 121 stores ground truth information (ground truth label) indicating whether or not each data (image) includes a smile in association with each data.

In addition, the data information storage unit 121 may store data so as to be identifiable such that each data can be identified as learning data or evaluation data, or the like. For example, the data information storage unit 121 stores the learning data and the evaluation data in a distinguishable manner. The data information storage unit 121 may also store information to identify whether each data is learning data or evaluation data. The data adjustment device 100 learns the model on the basis of each data used as learning data and ground truth information. The data adjustment device 100 measures the accuracy of the model on the basis of each data used as evaluation data and ground truth information. The data adjustment device 100 measures the accuracy of the model by collecting a result obtained by comparing the output result output from the model in a case where the evaluation data is input with the ground truth information.

The model information storage unit 122 according to the embodiment stores information regarding the model. For example, the model information storage unit 122 stores information (model data) indicating a structure of a model (network). FIG. 6 is a diagram illustrating an example of the model information storage unit according to an embodiment of the present disclosure. FIG. 6 illustrates an example of the model information storage unit 122 according to the embodiment. In the example illustrated in FIG. 6, the model information storage unit 122 includes items such as “model ID”, “use”, and “model data”.

The “model ID” indicates identification information for identifying the model. “Use” indicates a use of the corresponding model. “Model data” indicates data of the model. Although FIG. 6 illustrates an example in which conceptual information such as “MDT1” is stored in “model data”, in reality, the “model data” includes various types of information constituting the model, such as information regarding a network and a function included in the model.

In the example illustrated in FIG. 6, the model (model M1) identified by the model ID “M1” indicates that the use is “image recognition (smile detection)”. Model M1 is a model used for image recognition, and indicates that model M1 is used for smile detection. In addition, the model data of the model M1 indicates the model data MDT1.

Note that the model information storage unit 122 is not limited to the above, and may store various types of information depending on the purpose. For example, the model information storage unit 122 stores parameter information of a model learned (generated) by the learning processing.

The threshold information storage unit 123 according to the embodiment stores various kinds of information regarding threshold values. The threshold information storage unit 123 stores various types of information related to threshold values used for comparison with scores. FIG. 7 is a diagram illustrating an example of a threshold information storage unit according to an embodiment. The threshold information storage unit 123 illustrated in FIG. 7 includes items such as “threshold ID” and “threshold value”.

The “threshold ID” indicates identification information for identifying the threshold value. In addition, the “threshold value” indicates a specific value of the threshold identified by the corresponding threshold ID. In addition, information indicating the use is stored in association with each threshold value.

In the example of FIG. 7, the threshold value (first threshold TH1) identified by the threshold ID “TH1” is stored in association with information indicating that the threshold value is used for discriminating of data having a low degree of influence. In this case, the first threshold value TH1 is used to discriminate data having a low degree of influence, that is, data to be excluded. Further, the value of the first threshold value TH1 is indicated as “VL1”. Note that in the example of FIG. 7, the first threshold value TH1 is indicated by an abstract code such as “VL1”, but the value of the first threshold value TH1 is a specific numerical value (for example, 0.3 or the like).

In addition, the threshold value (second threshold TH2) identified by the threshold ID “TH2” is stored in association with information indicating that the threshold value is used for discriminating of data having a high degree of influence. In this case, the second threshold value TH2 is used to discriminate data having a high degree of influence, that is, data to which new data is to be added. Further, the value of the second threshold value TH2 is indicated as “VL2”. Note that in the example of FIG. 7, the second threshold value TH2 is indicated by an abstract code such as “VL2”, but the value of the second threshold value TH2 is a specific numerical value (for example, 0.75 or the like).

Note that the threshold information storage unit 123 is not limited to the above, and may store various types of information depending on the purpose.

Returning to FIG. 4, the description will be continued. The control unit 130 is implemented by, for example, a central processing unit (CPU), a micro processing unit (MPU), or the like executing a program stored in the data adjustment device 100 (for example, an information processing program such as a data adjustment processing program according to the present disclosure) using a random access memory (RAM) or the like as a work area. Furthermore, the control unit 130 is a controller, and is implemented by, for example, an integrated circuit such as an application specific integrated circuit (ASIC) or a field programmable gate array (FPGA).

As illustrated in FIG. 4, the control unit 130 includes an acquisition unit 131, a learning unit 132, a measuring unit 133, an adjustment unit 134, and a transmission unit 135, and implements or executes functions and actions of information processing described below. Note that the internal configuration of the control unit 130 is not limited to the configuration illustrated in FIG. 4, and may be another configuration as long as information processing to be described later is performed. Furthermore, connection relationship of each of the processing units included in the control unit 130 is not limited to the connection relationship illustrated in FIG. 4, and may be another connection relationship.

The acquisition unit 131 acquires various types of information. The acquisition unit 131 acquires various types of information from an external information processing apparatus. The acquisition unit 131 acquires various types of information from the terminal device 10.

The acquisition unit 131 acquires various types of information from the storage unit 120. The acquisition unit 131 acquires various types of information from the data information storage unit 121, the model information storage unit 122, and the threshold information storage unit 123.

The acquisition unit 131 acquires various types of information learned by the learning unit 132. The acquisition unit 131 acquires various types of information measured by the measuring unit 133. The acquisition unit 131 acquires various types of information adjusted by the adjustment unit 134.

The learning unit 132 learns various types of information. The learning unit 132 learns various types of information on the basis of information from the external information processing apparatus or information stored in the storage unit 120. The learning unit 132 learns various types of information on the basis of information stored in the data information storage unit 121. The learning unit 132 stores the model generated by learning in the model information storage unit 122.

The learning unit 132 performs learning processing. The learning unit 132 performs various kinds of learning. The learning unit 132 learns various types of information on the basis of the information acquired by the acquisition unit 131. The learning unit 132 learns (generates) the model. The learning unit 132 learns various types of information, such as a model. The learning unit 132 generates a model by learning. The learning unit 132 learns the model using various techniques related to machine learning. For example, the learning unit 132 learns parameters of a model (network). The learning unit 132 learns the model using various techniques related to machine learning.

The learning unit 132 learns parameters of a network. For example, the learning unit 132 learns parameters of a network of the model M1. The learning unit 132 learns parameters of a network of the model M1.

The learning unit 132 performs learning processing on the basis of the learning data (labeled training data) stored in the data information storage unit 121. The learning unit 132 generates the model M1 by performing learning processing using the learning data stored in the data information storage unit 121. For example, the learning unit 132 generates a model used for image recognition (smile detection). The learning unit 132 learns parameters of a network of the model M1 to generate the model M1.

The technique of learning by the learning unit 132 is not particularly limited, but for example, learning data in which label information (presence or absence of a smile, etc.) is associated with an image group may be prepared, and the learning data may be input to a calculation model based on a multilayer neural network to perform learning. Furthermore, for example, a technique based on a deep neural network (DNN) such as a convolutional neural network (CNN) or a 3D-CNN may be used. In a case where the object is the time series data such as a moving image of a video or the like, the learning unit 132 may use a technique based on a Recurrent Neural Network (RNN) or a Long Short-Term Memory unit (LSTM) obtained by extending the RNN.

The learning unit 132 executes learning processing using a data set. The learning unit 132 executes learning processing using the data set adjusted by the adjustment unit 134. The learning unit 132 executes learning processing using the data set adjusted by the adjustment unit 134 to update a model. The learning unit 132 executes learning processing using the data set adjusted by the adjustment unit 134 to update parameters of the model. The learning unit 132 executes learning processing using the data set adjusted by the adjustment unit 134 to update the model M1.

The measuring unit 133 measures various processing. The measuring unit 133 functions as a measurement means. The measuring unit 133 functions as a measurement means that measures the degree of influence on learning given by learning data used for learning of the neural network. The measuring unit 133 measures various types of processing on the basis of various types of information from the external information processing apparatus. The measuring unit 133 measures various types of processing on the basis of information stored in the storage unit 120. The measuring unit 133 measures various kinds of processing on the basis of information stored in the data information storage unit 121, the model information storage unit 122, or the threshold information storage unit 123. The measuring unit 133 generates various types of information by measuring processing.

The measuring unit 133 measures various types of processing on the basis of various types of information acquired by the acquisition unit 131. The measuring unit 133 measures various types of processing on the basis of various types of information learned by the learning unit 132. The measuring unit 133 extracts various types of information on the basis of various types of information acquired by the acquisition unit 131. The measuring unit 133 extracts various types of processing on the basis of various types of information learned by the learning unit 132. The measuring unit 133 extracts various types of information on the basis of information adjusted by the adjustment unit 134.

The measuring unit 133 decides various types of information. The measuring unit 133 determines various types of information. The measuring unit 133 discriminates various types of information. The measuring unit 133 discriminates necessity of each data on the basis of the degree of influence of each data.

The measuring unit 133 measures the degree of influence on learning given by learning data used for learning of a machine learning model. The measuring unit 133 measures the degree of influence on the basis of the loss function. The measuring unit 133 measures the degree of influence using a technique allowing for measuring the degree of influence. The measuring unit 133 measures the degree of influence using an influence function. The measuring unit 133 measures the degree of influence of one data on the basis of a difference between a case of the data set and a case of excluding the one data from the data set. The measuring unit 133 measures the degree of influence of learning data used for learning of the neural network.

The adjustment unit 134 adjusts various types of information. The adjustment unit 134 functions as an adjustment means that adjusts a data set. The adjustment unit 134 functions as the adjustment means that excludes data measured to have a low degree of influence from the data set, acquires new data that is new data corresponding to data measured to have a high degree of influence, and adds the acquired new data to the data set. The adjustment unit 134 adjusts various types of information on the basis of information from the external information processing apparatus or information stored in the storage unit 120. The adjustment unit 134 adjusts various types of information on the basis of information from another information processing apparatus such as the terminal device 10 or the like. The adjustment unit 134 adjusts various kinds of information on the basis of information stored in the data information storage unit 121, the model information storage unit 122, or the threshold information storage unit 123.

The adjustment unit 134 adjusts various types of information on the basis of various types of information acquired by the acquisition unit 131. The adjustment unit 134 adjusts various types of processing on the basis of various types of information learned by the learning unit 132. The adjustment unit 134 adjusts various types of information on the basis of various types of information adjusted by measurement of processing of the measuring unit 133.

The adjustment unit 134 adjusts the data set by excluding data from the data set or by adding new data to the data set on the basis of the measured result by the measuring unit 133. The adjustment unit 134 excludes a first piece of data with a low degree of influence from the data set. The adjustment unit 134 excludes the first piece of data with the degree of influence lower than a first threshold value from the data set.

The adjustment unit 134 adds a new data, which is data to be newly added corresponding to a second piece of data with a high degree of influence, to the data set. The adjustment unit 134 adds the new data corresponding to the second piece of data with a degree of influence higher than the second threshold value to the data set. The adjustment unit 134 adds the new data acquired from the external device to the data set. The adjustment unit 134 adds the new data acquired from the storage unit that stores data to the data set.

The adjustment unit 134 generates a new data and adds the generated new data to the data set. The adjustment unit 134 generates a new data using the second piece of data and adds the generated new data to the data set. The adjustment unit 134 generates a new data using data augmentation and adds the generated new data to the data set. The adjustment unit 134 generates a new data similar to the second piece of data and adds the generated new data to the data set. For example, the adjustment unit 134 uses the second piece of data as original data and generates an image similar to the original data using data augmentation. For example, the adjustment unit 134 uses the second piece of data as the original data, and generates an image similar to the original data by reducing the original data, enlarging a part of the original data, rotating the original data to the left and right, or moving the original data in the up, down, left, and right directions. Note that the above is an example, and the adjustment unit 134 may generate new data to be added to the data set by various techniques. For example, and the adjustment unit 134 may generate new data to be added to the data set by a technique such as GAN described above.

The transmission unit 135 transmits various types of information. The transmission unit 135 transmits various types of information to the external information processing apparatus. The transmission unit 135 provides various types of information to the external information processing apparatus. For example, the transmission unit 135 transmits various types of information to another external information processing apparatus, such as the terminal device 10. The transmission unit 135 provides the information stored in the storage unit 120. The transmission unit 135 transmits the information stored in the storage unit 120.

The transmission unit 135 provides various types of information on the basis of information from another information processing apparatus such as the terminal device 10 or the like. The transmission unit 135 provides various types of information on the basis of information stored in the storage unit 120. The transmission unit 135 provides various kinds of information on the basis of information stored in the data information storage unit 121, the model information storage unit 122, or the threshold information storage unit 123.

The transmission unit 135 transmits request information that requests the new data to the external device. The transmission unit 135 transmits request information that requests the new data to the terminal device 10. The transmission unit 135 transmits request information that requests data similar to learning data in which a degree of influence on the learning in the machine learning model is equal to or higher than a predetermined reference to the terminal device 10. The transmission unit 135 transmits request information that requests data similar to learning data in which a degree of influence on the learning in the machine learning model is equal to or higher than a predetermined threshold to the terminal device 10.

### 11. Model (Network) Example

As described above, the data adjustment device 100 may use a model (network) in the form of a neural network (NN) such as a deep neural network (DNN). Note that the data adjustment device 100 is not limited to the neural network, and may use various types of models (functions) such as a regression model such as a support vector machine (SVM). As described above, the data adjustment device 100 may use a model (function) of an arbitrary format. The data adjustment device 100 may use various regression models such as a nonlinear regression model and a linear regression model.

In this regard, an example of the network structure of the model will be described with reference to FIG. 8. FIG. 8 is a diagram illustrating an example of a network corresponding to a model. The network NW1 illustrated in FIG. 8 illustrates a neural network including a plurality of (multilayer) intermediate layers between the input layer INL and the output layer OUTL. The network NW1 illustrated in FIG. 8 corresponds to the neural network NN in FIG. 1. For example, the data adjustment device 100 may learn parameters of the network NW1 illustrated in FIG. 8.

A network NW1 illustrated in FIG. 8 corresponds to the network of the model M1, and is a conceptual diagram illustrating a neural network (model) used for image recognition. For example, if an image is input from the input layer INL side, for example, the network NW1 outputs the recognition result from the output layer OUTL. For example, the data adjustment device 100 inputs information to the input layer INL in the network NW1 to output a recognition result corresponding to the input from the output layer OUTL.

Note that, in FIG. 8, the network NW1 is illustrated as an example of a model (network), but the network NW1 may have various forms depending on the use and the like. For example, the data adjustment device 100 learns the model M1 by learning parameters (weights) of the model M1 having the structure of the network NW1 illustrated in FIG. 8.

### 1-4. Configuration of Terminal Device According to Embodiment

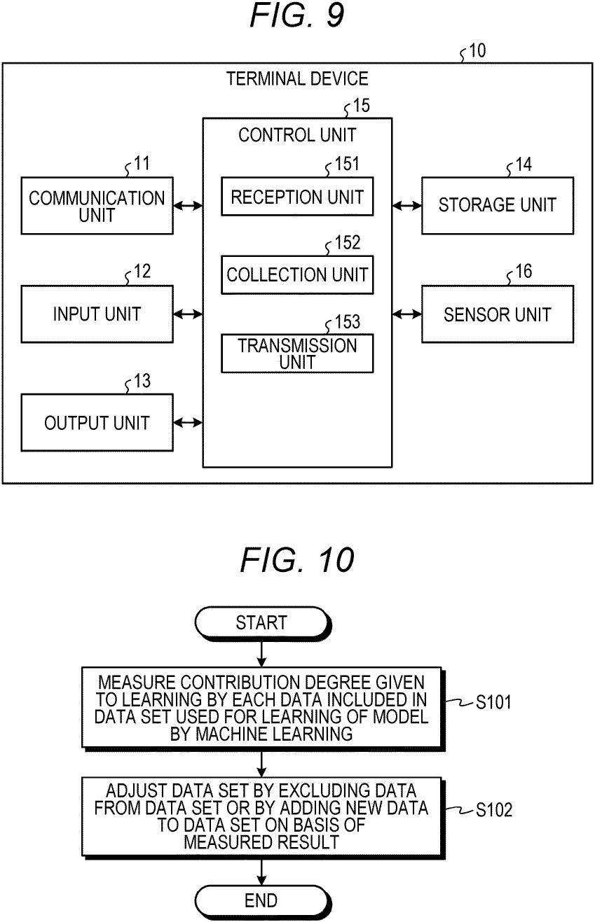

Next, a configuration of the terminal device 10, which is an example of the terminal device that executes the information processing according to the embodiment, will be described. FIG. 9 is a diagram illustrating a configuration example of a terminal device according to an embodiment of the present disclosure.

As illustrated in FIG. 9, the terminal device 10 includes a communication unit 11, an input unit 12, an output unit 13, a storage unit 14, a control unit 15, and a sensor unit 16. Note that the terminal device 10 may have any device configuration as long as it can collect data and provide the data to the data adjustment device 100. For example, as long as the terminal device 10 includes the communication unit 11 that communicates with the data adjustment device 100 and the control unit 15 that performs processing of collecting data, other configurations may be arbitrary. Depending on the type of the terminal device 10, for example, the terminal device 10 does not necessarily include any of the input unit 12, the output unit 13, the storage unit 14, and the sensor unit 16.

For example, in a case where the terminal device 10 is an image sensor (imager), the terminal device 10 may have a configuration including only the communication unit 11, the control unit 15, and the sensor unit 16. For example, an imaging element used in an image sensor (imager) is a complementary metal oxide semiconductor (CMOS). Note that the imaging element used for the image sensor (imager) is not limited to the CMOS, and may be various imaging elements such as a charge coupled device (CCD). Furthermore, for example, in a case where the terminal device 10 is a data server, the terminal device 10 may have a configuration including only the communication unit 11, the storage unit 14, and the control unit 15. Furthermore, for example, in a case where the terminal device 10 is a moving object, the terminal device 10 may have a configuration including a mechanism for realizing movement of a drive unit (motor) or the like.

The communication unit 11 is realized by, for example, an NIC, a communication circuit, or the like. The communication unit 11 is connected to a network N (the Internet or the like) in a wired or wireless manner, and transmits and receives information to and from other devices such as the data adjustment device 100 via the network N.

The input unit 12 receives various inputs. The input unit 12 receives a user operation. The input unit 12 may receive an operation (user operation) on the terminal device 10 used by the user as an operation input by the user. The input unit 12 may receive information regarding a user operation using a remote controller via the communication unit 11. Furthermore, the input unit 12 may include a button provided on the terminal device 10, or a keyboard or a mouse connected to the terminal device 10.

For example, the input unit 12 may have a touch panel capable of realizing functions equivalent to those of a remote controller, a keyboard, and a mouse. In this case, various types of information are input to the input unit 12 via the display (output unit 13). The input unit 12 receives various operations from the user via the display screen by a function of a touch panel realized by various sensors. That is, the input unit 12 receives various operations from the user via the display (output unit 13) of the terminal device 10. For example, the input unit 12 receives user operations via the display (output unit 13) of the terminal device 10.

The output unit 13 outputs various types of information. The output unit 13 has a function of displaying information. The output unit 13 is provided to the terminal device 10 and displays various types of information. The output unit 13 is implemented by, for example, a liquid crystal display, an organic electroluminescence (EL) display, or the like. The output unit 13 may have a function of outputting sound. For example, the output unit 13 includes a speaker that outputs sound.

The storage unit 14 is implemented by, for example, a semiconductor memory element such as a RAM or a flash memory, or a storage device such as a hard disk or an optical disk. The storage unit 14 stores various types of information used for displaying information.

Returning to FIG. 9, the description will be continued. The control unit 15 is implemented by, for example, a CPU, an MPU, or the like executing a program (for example, an information processing program such as a data provision program according to the present disclosure) stored inside the terminal device 10 using a RAM or the like as a work area. Furthermore, the control unit 15 is a controller, and may be implemented by, for example, an integrated circuit such as an ASIC or an FPGA.

As illustrated in FIG. 9, the control unit 15 includes a reception unit 151, a collection unit 152, and a transmission unit 153, and implements or executes functions and actions of information processing described below. Note that the internal configuration of the control unit 15 is not limited to the configuration illustrated in FIG. 9, and may be another configuration as long as information processing to be described later is performed.

The reception unit 151 receives various types of information. The reception unit 151 receives various types of information from the external information processing apparatus. The reception unit 151 receives various types of information from another external information processing apparatus, such as the data adjustment device 100.

The reception unit 151 receives request information indicating data requested for acquiring by an external device having learning data used for learning of a model by machine learning, from the external device. The reception unit 151 receives, from the data adjustment device 100, request information indicating data requested to be acquired by the data adjustment device 100. The reception unit 151 receives request information for requesting learning data used for the machine learning from an external device (the data adjustment device 100 or the like) having a machine learning model. The reception unit 151 receives request information that requests data similar to learning data in which a degree of influence on the learning in the machine learning model is equal to or higher than a predetermined reference.

The collection unit 152 collects various types of information. The collection unit 152 decides collecting various types of information. The collection unit 152 collects various types of information on the basis of information from the external information processing apparatus. The collection unit 152 collects various types of information on the basis of information from the data adjustment device 100. The collection unit 152 collects various types of information in accordance with an instruction from the data adjustment device 100. The collection unit 152 collects various types of information on the basis of information stored in the storage unit 14.

The collection unit 152 collects data corresponding to the request information received by the reception unit 151. The collection unit 152 collects data corresponding to the request information received by the reception unit 151 as data (provision data) to be provided to the data adjustment device 100. The collection unit 152 collects provision data by extracting data corresponding to the request information received by the reception unit 151 from the storage unit 14. The collection unit 152 collects provision data by detecting, by the sensor unit 16, data corresponding to the request information received by the reception unit 151.

The transmission unit 153 transmits various types of information to the external information processing apparatus. For example, the transmission unit 153 transmits various types of information to another external information processing apparatus, such as the data adjustment device 100. The transmission unit 153 transmits the information stored in the storage unit 14.

The transmission unit 153 transmits various types of information on the basis of information from another external information processing apparatus, such as the data adjustment device 100. The transmission unit 153 transmits various types of information on the basis of information stored in the storage unit 14.

The transmission unit 153 transmits provision data collected as data corresponding to the request information to the external device. The transmission unit 153 transmits provision data collected as data corresponding to the request information to the data adjustment device 100. The transmission unit 153 transmits provision data collected by the collection unit 152 to the data adjustment device 100.

For example, in a case where the terminal device 10 includes the sensor unit 16, the transmission unit 153 transmits the sensor information detected by the sensor unit 16 to the data adjustment device 100. The transmission unit 153 transmits image information detected by an image sensor (image sensor) of the sensor unit 16 to the data adjustment device 100.

The sensor unit 16 detects various sensor information. The sensor unit 16 has a function as an imaging unit that captures an image. The sensor unit 16 has a function of an image sensor and detects image information. The sensor unit 16 functions as an image input unit that receives an image as an input.

Note that the sensor unit 16 is not limited to the above, and may include various sensors. The sensor unit 16 may include various sensors such as a sound sensor, a position sensor, an acceleration sensor, a gyro sensor, a temperature sensor, a humidity sensor, an illuminance sensor, a pressure sensor, a proximity sensor, and a sensor for receiving biological information such as smell, sweat, heartbeat, pulse, and brain waves. In addition, the sensors that detect the various types of information in the sensor unit 16 may be common sensors or may be implemented by different sensors separately.

### 1-5. Procedure of Information Processing According to Embodiment

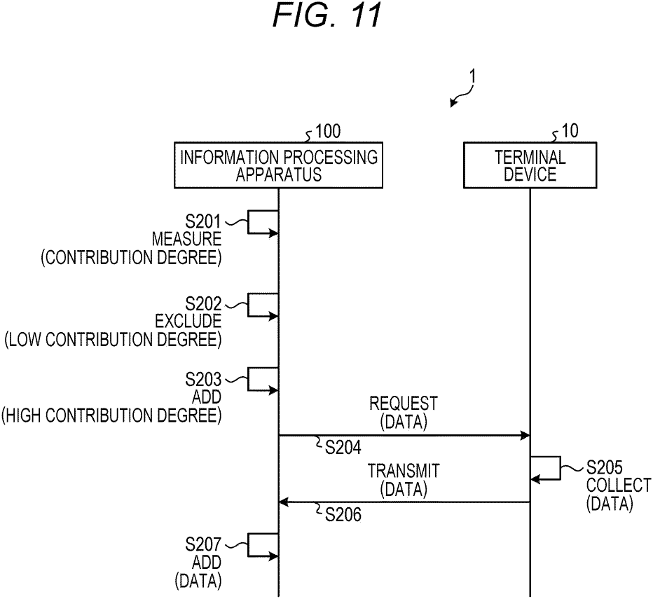

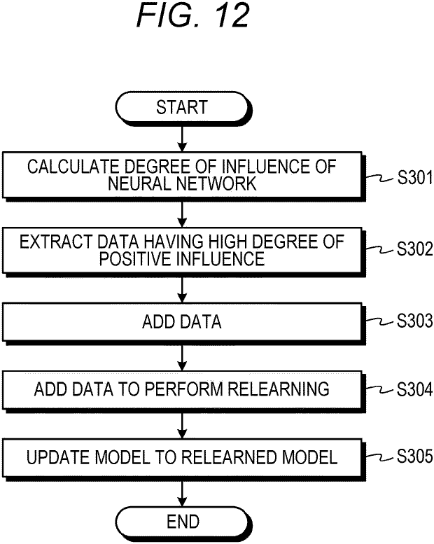

Next, a procedure of various types of information processing according to the embodiment will be described with reference to FIGS. 10 and 11.

### 11. Procedure of Processing Related to Data Adjustment Device

First, a procedure of processing related to the data adjustment device according to an embodiment of the present disclosure will be described with reference to FIG. 10. FIG. 10 is a flowchart illustrating processing of the data adjustment device according to an embodiment of the present disclosure. Specifically, FIG. 10 is a flowchart illustrating a procedure of information processing by the data adjustment device 100.

As illustrated in FIG. 10, the data adjustment device 100 measures the contribution degree given to the learning by each data included in the data set used for the learning of the model by the machine learning (step S101). Then, the data adjustment device 100 adjusts the data set by excluding data from the data set or by adding new data to the data set on the basis of the measured result (step S102).

### 12. Procedure of Processing Related to Data Adjustment System

Next, an example of specific processing related to the data adjustment system will be described with reference to FIG. 11. FIG. 11 is a sequence diagram illustrating a processing procedure of the data adjustment system according to an embodiment of the present disclosure.

As illustrated in FIG. 11, the data adjustment device 100 measures the degree of contribution of each data in learning (step S201). For example, the data adjustment device 100 measures the contribution degree given to learning of learning data used for learning of a model by machine learning.

The data adjustment device 100 excludes data having a low degree of contribution (step S202). The data adjustment device 100 excludes, from the data set, data whose contribution degree in learning is equal to or less than a threshold for discrimination of a low degree contribution.

The data adjustment device 100 adds data corresponding to data having a high degree of contribution (step S203). The data adjustment device 100 adds data whose contribution degree in learning is equal to or higher than a threshold for discrimination of a high degree contribution.

In the example of FIG. 8, the data adjustment device 100 requests the terminal device 10 for data corresponding to the data having a high degree of contribution (step S204). For example, the data adjustment device 100 requests the terminal device 10 for data similar to data having a high degree of contribution.

The terminal device 10 to which the data is requested collects data corresponding to the request (step S205). Then, the terminal device 10 transmits the collected data to the data adjustment device 100 (step S206) .

The data adjustment device 100 that has acquired the data from the terminal device 10 adds the acquired data to the data set (step S207) .

### 1-6. Data Adjustment Example Based on Degree of Influence

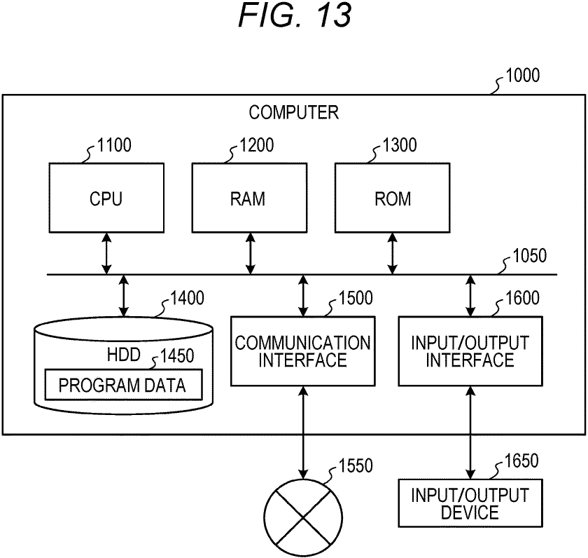

Here, an example of data adjustment based on the degree of influence will be described after description of a premise. Knowing the degree of influence of data on a deep neural network in machine learning also leads to improvement of a network. Specifically, increasing data having a degree of positive influence is useful for improving characteristics in machine learning. As a method of increasing the data, similar images can be increased by data augmentation (for example, by rotating the image so as to increase the similar images) as a method of padding the data. In addition, data similar to data having a positive influence can be found from data on the network so as to enhance the data. By adding those data and relearning the deep neural network, a more accurate deep neural network can be constructed. Explanation on this matter will be given with reference to FIG. 12. FIG. 12 is a flowchart illustrating an example of processing of data adjustment and learning based on the degree of influence.

As illustrated in FIG. 12, the data adjustment device 100 calculates the degree of influence of a neural network (step S301). For example, the data adjustment device 100 measures the degree of influence on learning given by learning data used for learning of the neural network.

Then, the data adjustment device 100 extracts data having a high degree of positive influence (step S302). For example, the direction to reduce the loss is a positive influence, and the direction to increase the loss is a negative influence, and so the higher the degree to the direction to reduce the loss, the higher the degree of positive influence. For example, the data adjustment device 100 extracts data having a degree of positive influence equal to or higher than a predetermined reference (threshold value or the like).

Then, the data adjustment device 100 adds data (step S303). The data adjustment device 100 adds data similar to data having a high degree of positive influence to the learning data. For example, the data adjustment device 100 may generate data similar to data having a high degree of positive influence by data augmentation, and add the generated data to the learning data. Furthermore, for example, the data adjustment device 100 may add, to the learning data, data similar to data having a high degree of positive influence among the data on the network.

Then, the data adjustment device 100 adds data to perform relearning (step S304). For example, the data adjustment device 100 relearns the model using the learning data to which the data is added in step S303.

Then, the data adjustment device 100 updates the model to the relearned model (step S305). For example, the data adjustment device 100 updates the model before relearning to the model after relearning. For example, the data adjustment device 100 updates the parameter of the model to the relearned parameter.

### 11. Specific Example of Adjustment

As a specific example of the processing of FIG. 12 described above, a case where the data adjustment device 100 is a camera equipped with an image classification function by a deep neural network will be described as an example. In this case, first, the data adjustment device 100 calculates data having a degree of positive influence. Then, the data adjustment device 100 generates and collects data similar to the data by data augmentation, or collects the data from the network. The data adjustment device 100 adds the collected data and relearns the original deep neural network. As a result, the data adjustment device 100 can improve the accuracy of the image classification function of the camera.

Note that a system (data adjustment system 1) that autonomously searches for data having a positive influence in data increase may be configured. As a result, the data adjustment system 1 can search for data without human intervention and automatically perform relearning. In this case, the data adjustment system 1 is a learning system that autonomously evolves the deep neural network. With the data adjustment system 1, the deep neural network can evolve its own performance.

### 2. Other Embodiments

The processing according to each of the above-described embodiments may be performed in various different forms (modifications) other than the above-described embodiments and modifications.

### 2-1. Other Configuration Examples

Moreover, the above example has described the case where the data adjustment device 100 and the terminal device 10 are two separate entities, but these devices may be integrated. For example, the data adjustment device 100 may be a device having a function of adjusting learning data and a function of collecting data. For example, the data adjustment device 100 is an information processing apparatus that acquires new learning data on the basis of the degree of influence. In this case, the data adjustment device 100 includes a model trained by using machine learning, a measuring unit configured to measure a degree of influence of learning data on the machine learning, the learning data being used for the machine learning, and a control unit (an acquisition unit, or the like) configured to acquire new learning data on the basis of the degree of influence. The data adjustment device 100 may be a camera, a smartphone, a television, an automobile, a drone, a robot, or the like. As described above, the data adjustment device 100 may be a terminal device that autonomously collects learning data having a high degree of influence.

### 2-2. Others

Further, among the each processing described in the above embodiments, all or part of the processing described as being performed automatically can be performed manually, or all or part of the processing described as being performed manually can be performed automatically by a known method. In addition, the processing procedure, specific name, and information including various data and parameters illustrated in the specification and the drawings can be arbitrarily changed unless otherwise specified. For example, the various types of information illustrated in each drawing are not limited to the illustrated information.

In addition, each component of each device illustrated in the drawings is functionally conceptual, and is not necessarily physically configured as illustrated in the drawings. That is, a specific form of distribution and integration of each device is not limited to the illustrated form, and all or a part thereof can be functionally or physically distributed and integrated in an arbitrary unit according to various loads, usage conditions, and the like.

In addition, the above-described embodiments and modifications can be appropriately combined within a range in which the processing contents do not contradict each other.

Furthermore, the effects described in the present specification are merely examples and are not limited, and other effects may be provided.

### 3. Effects According to Present Disclosure

As described above, the data adjustment system (the data adjustment system 1 in the embodiment) according to the present disclosure includes an information processing apparatus (the data adjustment device 100 in the embodiment) including a measuring unit and an adjustment unit, and a terminal device (the terminal device 10 in the embodiment). The measuring unit measures the degree of influence on learning given by learning data used for learning of the neural network. The adjustment unit adjusts the learning data by excluding data measured to have a low degree of influence, acquiring new data, which is new data corresponding to data measured to have a high degree of influence, from the terminal device or the database, and adding the acquired new data.

As described above, the data adjustment system according to the present disclosure uses the degree of influence on learning given by learning data to exclude data or add data. As a result, the data adjustment system can make the data used for learning adjustable by increasing or decreasing the data according to the degree of influence of each data.

As described above, a data adjustment device according to the present disclosure (the data adjustment device 100 in the embodiment) includes a measuring unit (the measuring unit 133 in the embodiment) and an adjustment unit (the adjustment unit 134 in the embodiment). The measuring unit measures the degree of influence on learning given by each data included in a learning data set used for learning of a model by machine learning. The adjustment unit adjusts the learning data, on the basis of the measurement result by the measuring unit, by excluding predetermined data from the learning data used for learning of a model by machine learning or adding new data to the learning data.

As described above, the data adjustment device according to the present disclosure uses the degree of influence on learning given by learning data to exclude data or add data. As a result, the data adjustment system can make the data used for learning adjustable by increasing or decreasing the data according to the degree of influence of each data.

Furthermore, the measuring unit measures the degree of influence on the basis of the loss function. As described above, the data adjustment device can accurately measure the degree of influence of each data by measuring the degree of influence on the basis of the loss function. Therefore, the data adjustment device can make the data used for learning adjustable.

Furthermore, the measuring unit measures the degree of influence using a technique allowing for measuring the degree of influence. As described above, the data adjustment device can accurately measure the degree of influence of each data by measuring the degree of influence using a technique allowing for measuring the degree of influence. Therefore, the data adjustment device can make the data used for learning adjustable.

Furthermore, the measuring unit measures the degree of influence using an influence function. As described above, the data adjustment device can accurately measure the degree of influence of each data by measuring the degree of influence using the influence function. Therefore, the data adjustment device can make the data used for learning adjustable.

In addition, the measuring unit measures the degree of influence of the predetermined data on the basis of a difference between a case of the learning data and a case of excluding the predetermined data from the learning data. As described above, the data adjustment device can accurately measure the degree of influence of certain data by measuring the degree of influence on the basis of a difference between a case where the certain data is excluded from the learning data and a case where the certain data is not excluded from the learning data. Therefore, the data adjustment device can make the data used for learning adjustable.

Furthermore, the adjustment unit excludes the first piece of data with a low degree of influence from the learning data. As described above, the data adjustment device can appropriately exclude data that does not contribute to learning from the learning data by excluding the first piece of data having a low degree of influence from the learning data. Therefore, the data adjustment device can make the data used for learning adjustable.

Furthermore, the adjustment unit excludes the first piece of data with the degree of influence lower than the first threshold value from the learning data. As described above, the data adjustment device can appropriately exclude data that does not contribute to learning from the learning data by excluding the first piece of data having a degree of influence lower than the first threshold value from the learning data. Therefore, the data adjustment device can make the data used for learning adjustable.

In addition, the adjustment unit adds the new data to the learning data, the new data being data to be newly added corresponding to the second piece of data with a high degree of influence. In this manner, the data adjustment device can appropriately add data contributing to learning to the learning data by adding new data corresponding to the second piece of data having a high degree of influence to the learning data. Therefore, the data adjustment device can make the data used for learning adjustable.

In addition, the adjustment unit adds new data corresponding to the second piece of data having a degree of influence higher than the second threshold value to the learning data. In this manner, the data adjustment device can appropriately add data contributing to learning to the learning data by adding new data corresponding to the second piece of data having a degree of influence higher than the second threshold value to the learning data. Therefore, the data adjustment device can make the data used for learning adjustable.

Furthermore, the data adjustment device according to the present disclosure includes a transmission unit (the transmission unit 135 in the embodiment). The transmission unit transmits request information for requesting new data to an external device (in the embodiment, the terminal device 10 such as a data server, a camera, an image sensor, or a moving object). The adjustment unit adds the new data acquired from the external device to the learning data. In this manner, the data adjustment device can appropriately add data contributing to learning to the learning data by requesting new data to an external device and adding the new data acquired from the external device to the learning data. Therefore, the data adjustment device can make the data used for learning adjustable.

Further, the adjustment unit adds the new data acquired from the storage unit that stores data to the learning data. In this manner, the data adjustment device can appropriately add data contributing to learning to the learning data by acquiring new data from a storage unit that stores data and adding the acquired new data to the learning data. Therefore, the data adjustment device can make the data used for learning adjustable.

Furthermore, the adjustment unit generates a new data and adds the generated new data to the learning data. In this manner, the data adjustment device can appropriately add data contributing to learning to the learning data by generating new data and adding the generated new data to the learning data. Therefore, the data adjustment device can make the data used for learning adjustable.

Furthermore, the adjustment unit generates a new data using data augmentation and adds the generated new data to the learning data. In this manner, the data adjustment device can generate new data having a high degree of contribution like the second piece of data having a high degree of contribution and add the new data to the learning data by generating the new data using data augmentation. Therefore, the data adjustment device can make the data used for learning adjustable.

Furthermore, the adjustment unit generates a new data using the second piece of data and adds the generated new data to the learning data. In this manner, the data adjustment device can generate new data having a high degree of contribution like the second piece of data having a high degree of contribution and add the new data to the learning data by generating the new data using the second piece of data. Therefore, the data adjustment device can make the data used for learning adjustable.

Furthermore, the adjustment unit generates a new data similar to the second piece of data and adds the generated new data to the learning data. In this manner, the data adjustment device can generate new data having a high degree of contribution similar to the second piece of data having a high degree of contribution and add the new data to the learning data by generating the new data similar to the second piece of data. Therefore, the data adjustment device can make the data used for learning adjustable.

In addition, the measuring unit measures the degree of influence of learning data used for learning of the neural network. As described above, the data adjustment device excludes data from the learning data used for learning of the neural network or adds data to the learning data. As a result, the data adjustment system can make the data used for learning of neural network adjustable by increasing or decreasing the data of learning data according to the degree of influence of each data.

Furthermore, the data adjustment device according to the present disclosure includes a learning unit (the learning unit 132 in the embodiment). The learning unit executes learning processing using the learning data subjected to the adjustment by the adjustment unit. As described above, the data adjustment device executes the learning processing using the adjusted learning data, so that the data adjustment device can perform learning using the learning data that enables an accurate model to be learned. The data adjustment device repeats the adjustment processing of learning data and the learning processing using the adjusted learning data, so that the data adjustment device can learn a model using the learning data that enables a more accurate model to be learned.

As described above, a terminal device (in the embodiment, the terminal device 10 such as a data server, a camera, an image sensor, or a mobile body) according to the present disclosure includes the reception unit (the reception unit 151 in the embodiment) and the transmission unit (the transmission unit 153 in the embodiment). The reception unit receives request information for requesting learning data used for the machine learning from an external device (the data adjustment device 100 in the embodiment) having a machine learning model. The transmission unit transmits data collected as data corresponding to the request information to the external device.

As described above, in response to a request from an external device having learning data used for the learning of a model by machine learning, the terminal device according to the present disclosure provides data corresponding to the request to the external device. As a result, the external device having the learning data can adjust the learning data by adding the data acquired from the terminal device to the learning data. Therefore, the terminal device can make the data used for learning adjustable.

Furthermore, the learning data requested by the request information according to the present disclosure includes data similar to learning data in which a degree of influence on the learning in the machine learning model is equal to or higher than a predetermined reference. In this manner, by requesting data similar to the learning data having the degree of influence equal to or higher than the predetermined reference, data useful for learning is collected, and learning processing is executed using the data, so that learning can be performed using the learning data that enables an accurate model to be learned.

As described above, the information processing apparatus (the data adjustment device 100 in the embodiment) according to the present disclosure includes a model trained by using machine learning, a measuring unit configured to measure a degree of influence of learning data on the machine learning, the learning data being used for the machine learning, and a control unit configured to acquire new learning data on the basis of the degree of influence.

As described above, the information processing apparatus according to the present disclosure can collect data useful for learning and efficiently adjust learning data by acquiring new learning data on the basis of the degree of influence of learning. Therefore, the information processing apparatus can make the data used for learning adjustable.

### 4. Hardware Configuration

The information device such as the data adjustment device 100 and the terminal device 10 according to each embodiment and modification described above is implemented by the computer 1000 having a configuration as illustrated in FIG. 13, for example. FIG. 13 is a hardware configuration diagram illustrating an example of the computer 1000 that realizes functions of an information processing apparatus such as the data adjustment device 100 and the terminal device 10. Hereinafter, the data adjustment device 100 according to the embodiment will be described as an example. The computer 1000 includes a CPU 1100, a RAM 1200, a read only memory (ROM) 1300, a hard disk drive (HDD) 1400, a communication interface 1500, and an input/output interface 1600. Each unit of the computer 1000 is connected by a bus 1050.

The CPU 1100 operates on the basis of a program stored in the ROM 1300 or the HDD 1400, and controls each unit. For example, the CPU 1100 develops a program stored in the ROM 1300 or the HDD 1400 in the RAM 1200, and executes processing corresponding to various programs.

The ROM 1300 stores a boot program such as a basic input output system (BIOS) executed by the CPU 1100 when the computer 1000 is activated, a program depending on hardware of the computer 1000, and the like.

The HDD 1400 is a computer-readable recording medium that non-transiently records a program executed by the CPU 1100, data used by the program, and the like. Specifically, the HDD 1400 is a recording medium that records an information processing program according to the present disclosure as an example of the program data 1450.

The communication interface 1500 is an interface for the computer 1000 to connect to an external network 1550 (for example, the Internet). For example, the CPU 1100 receives data from another device or transmits data generated by the CPU 1100 to another device via the communication interface 1500.

The input/output interface 1600 is an interface for connecting the input/output device 1650 and the computer 1000. For example, the CPU 1100 receives data from an input device such as a keyboard and a mouse via the input/output interface 1600. In addition, the CPU 1100 transmits data to an output device such as a display, a speaker, or a printer via the input/output interface 1600. Furthermore, the input/output interface 1600 may function as a media interface that reads a program or the like recorded in a predetermined recording medium. The medium is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

For example, in a case where the computer 1000 functions as the data adjustment device 100 according to the embodiment, the CPU 1100 of the computer 1000 realizes the functions of the control unit 130 and the like by executing the information processing program loaded on the RAM 1200. In addition, the HDD 1400 stores an information processing program according to the present disclosure and data in the storage unit 120. Note that the CPU 1100 reads program data 1450 from the HDD 1400 and executes the program data, but as another example, these programs may be acquired from another device via the external network 1550.

Additionally, the present technology may also be configured as below.
(1) A data adjustment system including:
   a measuring unit configured to measure a degree of influence of learning data on learning in a neural network, the learning data being used for the learning; and
   an adjustment unit configured to adjust the learning data by excluding data measured as having a low degree of influence, acquiring new data, or adding the acquired new data, the new data being data to be newly added corresponding to data measured as having a high degree of influence.
(2) A data adjustment device including:
   a measuring unit configured to measure a degree of influence of learning data on learning of a model by machine learning, the learning data being used for the learning; and
   an adjustment unit configured to adjust the learning data by excluding predetermined data from the learning data or adding new data to the learning data on the basis of a result obtained by the measurement in the measuring unit.
(3) The data adjustment device according to (2), in which
   the measuring unit measures the degree of influence on the basis of a loss function.
(4) The data adjustment device according to (2) or (3), in which
   the measuring unit measures the degree of influence using a technique allowing for measuring the degree of influence.
(5) The data adjustment device according to (4), in which
   the measuring unit measures the degree of influence using an influence function.
(6) The data adjustment device according to any one of (2) to (5), in which
   the measuring unit measures the degree of influence of the predetermined data on the basis of a difference between a case of the learning data and a case of excluding the predetermined data from the learning data.
(7) The data adjustment device according to any one of (2) to (6), in which
   the adjustment unit excludes a first piece of data with a low degree of influence from the learning data.
(8) The data adjustment device according to (7), in which
   the adjustment unit excludes the first piece of data with the degree of influence lower than a first threshold value from the learning data.
(9) The data adjustment device according to any one of (2) to (8), in which
   the adjustment unit adds the new data to the learning data, the new data being data to be newly added corresponding to a second piece of data with a high degree of influence.
(10) The data adjustment device according to (9), in which
   the adjustment unit adds the new data corresponding to the second piece of data with the degree of influence higher than a second threshold value to the learning data.
(11) The data adjustment device according to (9) or (10), further including:
   a transmission unit configured to transmit request information to an external device, the request information being used to request the new data, in which
   the adjustment unit adds the new data acquired from the external device to the learning data.
(12) The data adjustment device according to any one of (9) to (11), in which
   the adjustment unit adds the new data acquired from a storage unit to the learning data, the storage unit being configured to store data.
(13) The data adjustment device according to any one of (9) to (12), in which
   the adjustment unit generates the new data and adds the generated new data to the learning data.
(14) The data adjustment device according to (13), in which
   the adjustment unit generates the new data using the second piece of data and adds the generated new data to the learning data.
(15) The data adjustment device according to (13) or (14), in which
   the adjustment unit generates the new data using data augmentation and adds the generated new data to the learning data.
(16) The data adjustment device according to any one of (13) to (15), in which
   the adjustment unit generates the new data similar to the second piece of data and adds the generated new data to the learning data.
(17) The data adjustment device according to any one of (2) to (16), in which
   the measuring unit measures the degree of influence of data included in the learning data used for learning in a neural network.
(18) The data adjustment device according to any one of (2) to (17), further including:
   a learning unit configured to execute learning processing using the learning data subjected to the adjustment by the adjustment unit.
(19) A data adjustment method executing processing including:
   measuring a degree of influence of learning data on learning of a model by machine learning, the learning data being used for the learning; and
   adjusting the learning data by excluding data from the learning data or by adding new data to the learning data on the basis of a measured result.
(20) A terminal device including:
   a reception unit configured to receive request information indicating data requested for acquiring by an external device having learning data used for learning of a model by machine learning, from the external device; and
   a transmission unit configured to transmit provision data collected as data corresponding to the request information to the external device.
(21) The terminal device according to (20), in which the learning data requested by the request information includes data similar to learning data in which a degree of influence on the learning in the machine learning model is equal to or higher than a predetermined reference.
(22) An information processing apparatus including:
   a model trained by using machine learning;
   a measuring unit configured to measure a degree of influence of learning data on the machine learning, the learning data being used for the machine learning; and
   a control unit configured to acquire new learning data on the basis of the degree of influence.

### REFERENCE SIGNS LIST

1 Data adjustment system
100 Data adjustment device (information processing apparatus)
110 Communication unit
120 Storage unit
121 Data information storage unit
122 Model information storage unit
123 Threshold information storage unit
130 Control unit
131 Acquisition unit
132 Learning unit
133 Measuring unit
134 Adjustment unit
135 Transmission unit
10 Terminal device (data server, camera, image sensor, moving object)
11 Communication unit
12 Input unit
13 Output unit
14 Storage unit
15 Control unit
151 Reception unit
152 Collection unit
153 Transmission unit
16 Sensor unit

1. A data adjustment system comprising:
an information processing apparatus; and
a terminal device,
wherein the information processing apparatus includes
a measuring unit configured to measure a degree of influence of learning data on learning in a neural network, the learning data being used for the learning, and
an adjustment unit configured to adjust the learning data by excluding data measured as having a low degree of influence, acquiring new data from the terminal device or a database, or adding the acquired new data, the new data being data to be newly added corresponding to data measured as having a high degree of influence.

2. A data adjustment device comprising:
a measuring unit configured to measure a degree of influence of learning data on learning of a model by machine learning, the learning data being used for the learning; and
an adjustment unit configured to adjust learning data by excluding predetermined data from the learning data or adding new data to the learning data on a basis of a result obtained by the measurement in the measuring unit.

3. The data adjustment device according to claim 2, wherein the measuring unit measures the degree of influence on a basis of a loss function.

4. The data adjustment device according to claim 2, wherein the measuring unit measures the degree of influence using a technique allowing for measuring the degree of influence.

5. The data adjustment device according to claim 4, wherein the measuring unit measures the degree of influence using an influence function.

6. The data adjustment device according to claim 2, wherein the measuring unit measures the degree of influence of the predetermined data on a basis of a difference between a case of the learning data and a case of excluding the predetermined data from the learning data.

7. The data adjustment device according to claim 2, wherein the adjustment unit excludes a first piece of data with a low degree of influence from the learning data.

8. The data adjustment device according to claim 7, wherein the adjustment unit excludes the first piece of data with the degree of influence lower than a first threshold value from the learning data.

9. The data adjustment device according to claim 2, wherein the adjustment unit adds the new data to the learning data, the new data being data to be newly added corresponding to a second piece of data with a high degree of influence.

10. The data adjustment device according to claim 9, wherein the adjustment unit adds the new data corresponding to the second piece of data with the degree of influence higher than a second threshold value to the learning data.

11. The data adjustment device according to claim 9, further comprising:
a transmission unit configured to transmit request information to an external device, the request information being used to request the new data,
wherein the adjustment unit adds the new data acquired from the external device to the learning data.

12. The data adjustment device according to claim 9, wherein the adjustment unit adds the new data acquired from a storage unit to the learning data, the storage unit being configured to store data.

13. The data adjustment device according to claim 9, wherein the adjustment unit generates the new data and adds the generated new data to the learning data.

14. The data adjustment device according to claim 13, wherein the adjustment unit generates the new data using the second piece of data and adds the generated new data to the learning data.

15. The data adjustment device according to claim 13, wherein the adjustment unit generates the new data using data augmentation and adds the generated new data to the learning data.

16. The data adjustment device according to claim 13, wherein the adjustment unit generates the new data similar to the second piece of data and adds the generated new data to the learning data.

17. The data adjustment device according to claim 2, wherein the measuring unit measures the degree of influence of data included in the learning data used for learning in a neural network.

18. The data adjustment device according to claim 2, further comprising:
a learning unit configured to execute learning processing using the learning data subjected to the adjustment by the adjustment unit.

19. A data adjustment method executing processing comprising:
measuring a degree of influence of data included in learning data on learning of a model by machine learning, the learning data being used for the learning; and
adjusting the learning data by excluding data from the learning data or by adding new data to the learning data on a basis of a measured result.

20. A terminal device comprising:
a reception unit configured to receive request information from an external device having a machine learning model, the request information requesting learning data to be used for machine learning; and
a transmission unit configured to transmit data collected as data corresponding to the request information to the external device.

21. The terminal device according to claim 20, wherein the learning data requested by the request information includes data similar to learning data in which a degree of influence on the learning in the machine learning model is equal to or higher than a predetermined reference.

22. An information processing apparatus comprising:
a model trained by using machine learning;
a measuring unit configured to measure a degree of influence of learning data on the machine learning, the learning data being used for the machine learning; and
a control unit configured to acquire new learning data on a basis of the degree of influence.
